(19) United States
(12) Patent Application Publication
(10) Pub. No.: US 2025/0311035 A1
(43) Pub. Date: Oct. 2, 2025

(54) TECHNIQUES FOR PROTOCOL DATA UNIT SESSIONS VIA MULTIPLE ACCESS NETWORKS

(71) Applicant: QUALCOMM Incorporated, San Diego, CA (US)

(72) Inventors: Dario Serafino TONESI, San Diego, CA (US); Stefano FACCIN, San Ysidro, CA (US); Ajith Tom PAYYAPPILLY, San Diego, CA (US); Juan ZHANG, San Diego, CA (US)

(21) Appl. No.: 19/051,673

(22) Filed: Feb. 12, 2025

Related U.S. Application Data
(60) Provisional application No. 63/572,882, filed on Apr. 1, 2024.

(51) Int. Cl. H04W 76/15; H04M 15/00; H04W 40/22

(52) U.S. Cl. CPC H04W 76/15; H04M 15/66; H04W 40/22

(57) ABSTRACT

Methods, systems, and devices for wireless communications are described that provide for a user equipment (UE) to receive a first signal that indicates the UE is to use non-integrated non-3GPP access (NIN3A) access traffic steering-switching-splitting (ATSSS) for a protocol data unit (PDU) session with a wireless network using both a first access link associated with a 3GPP link (or an integrated non-3GPP link) and a second access link associated with a non-integrated non-3GPP link. The UE may establish the PDU session using both the first access link and the second access link based on the NIN3A ATSSS. The PDU session may use extended UE route selection policy (URSP) rules that apply to the PDU session with a 3GPP access (3GPPA) link and an NIN3A link, or the PDU session may use extended ATSSS rules and N4 rules that explicitly include 3GPPA and NIN3A combinations.

### CROSS REFERENCE

The present application for patent claims the benefit of U.S. Provisional Patent Application No. 63/572,882 by TONESI et al., entitled “TECHNIQUES FOR PROTOCOL DATA UNIT SESSIONS VIA MULTIPLE ACCESS NETWORKS,” filed Apr. 1, 2024, assigned to the assignee hereof, and expressly incorporated by reference herein.

### FIELD OF TECHNOLOGY

The following relates to wireless communications, including techniques for protocol data unit sessions via multiple access networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for protocol data unit (PDU) sessions via multiple access networks (MA PDU session). A 3rd Generation Partnership Project (3GPP) wireless network may support both a 3GPP access (3GPPA) link and a non-integrated, non-3GPP access (NIN3A) link using what is referred to herein as ATSSS-Lite. NIN3A may provide improved flexibility and processing overhead as compared to integrated non-3GPP access (N3GPPA). To support ATSSS-Lite, the described techniques provide for a user equipment (UE) that receives a first signal that indicates the UE is to use NIN3A access traffic steering-switching-splitting (ATSSS) for a PDU session with a wireless network using both a first access link associated with a 3GPP link (or an integrated non-3GPP link) and a second access link associated with a non-integrated non-3GPP link. The UE may establish the MA PDU session using both the first access link and the second access link based on the NIN3A ATSSS, and may communicate with the wireless network via at least one of the first access link or the second access link based on the established MA PDU session. In some aspects, the UE may use extended UE route selection policy (URSP) rules that apply to the MA PDU session with a 3GPPA link and an NIN3A link. In such aspects, rules related to ATSSS (e.g., N4 rules, such as rules for ATSSS functionality) may be unchanged relative to ATSSS rules that apply to MA PDU session with a 3GPPA link and an integrated N3GPPA link. In other aspects, the MA PDU session may use extended ATSSS/N4 rules that explicitly include 3GPPA and NIN3A combinations. In such aspects, URSP rules may be unchanged relative to URSP rules that apply to PDU session with a 3GPPA link and an N3GPPA link.

A method for wireless communications by a UE is described. The method may include receiving a first signal that indicates that the UE is to use a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network, establishing the PDU session with the wireless network via both the first access link and the second access link based on the first signal, and communicating with the wireless network via at least one of the first access link or the second access link based on the established PDU session.

A UE for wireless communications is described. The UE may include one or more memories storing processor executable code, and one or more processors coupled with the one or more memories. The one or more processors may individually or collectively be operable to execute the code to cause the UE to receive a first signal that indicates that the UE is to use a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network, establish the PDU session with the wireless network via both the first access link and the second access link based on the first signal, and communicate with the wireless network via at least one of the first access link or the second access link based on the established PDU session.

Another UE for wireless communications is described. The UE may include means for receiving a first signal that indicates that the UE is to use a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network, means for establishing the PDU session with the wireless network via both the first access link and the second access link based on the first signal, and means for communicating with the wireless network via at least one of the first access link or the second access link based on the established PDU session.

A non-transitory computer-readable medium storing code for wireless communications is described. The code may include instructions executable by one or more processors to receive a first signal that indicates that the UE is to use a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network, establish the PDU session with the wireless network via both the first access link and the second access link based on the first signal, and communicate with the wireless network via at least one of the first access link or the second access link based on the established PDU session.

In some examples of the method, UEs, and non-transitory computer-readable medium described herein, the receiving the first signal may include operations, features, means, or instructions for receiving the first signal from a policy control function (PCF) of the wireless network, where the first signal provides a URSP rule, and where the communicating with the wireless network is based on applying ATSSS rules associated with access links that are integrated to the wireless network to a first integrated access link together with a second non-integrated access link.

In some examples of the method, UEs, and non-transitory computer-readable medium described herein, the receiving the first signal may include operations, features, means, or instructions for receiving the first signal from a session management function (SMF) of the wireless network that provides a set of ATSSS rules for the first type of ATSSS for the PDU session, where the set of ATSSS rules is for access links that are non-integrated in the wireless network. In some examples of the method, UEs, and non-transitory computer-readable medium described herein, the first signal provides URSP rules that provide an indication that a preference for the PDU session is for the first access link associated with the wireless network and the second access link that is non-integrated in the wireless network.

In some examples of the method, UEs, and non-transitory computer-readable medium described herein, the UE, in an absence of the first signal that indicates a URSP for the second access link that is non-integrated in the wireless network, is to use a second type of ATSSS including a PDU session with the wireless network in which both access links are integrated in the wireless network, and the communicating with the wireless network uses, for both the first access link and the second access link, ATSSS rules that are associated with the second type of ATSSS.

In some examples of the method, UEs, and non-transitory computer-readable medium described herein, the first signal implicitly indicates that the second access link is non-integrated in the wireless network. In some examples of the method, UEs, and non-transitory computer-readable medium described herein, the first signal includes a set of bits having a value that is mapped to a route selection descriptor component type identifier associated with a PDU session in which the second access link is non-integrated in the wireless network.

In some examples of the method, UEs, and non-transitory computer-readable medium described herein, the first signal indicates a selection for an active standby steering mode associated with the first access link and one or more other access links that is non-integrated in the wireless network. In some examples of the method, UEs, and non-transitory computer-readable medium described herein, the first signal indicates a selection for a priority based steering mode associated with the first access link and one or more other access links that are non-integrated in the wireless network. In some examples of the method, UEs, and non-transitory computer-readable medium described herein, the first signal indicates a selection for a redundant steering mode (RSM) associated with the first access link and one or more other access links that are non-integrated in the wireless network. In some examples of the method, UEs, and non-transitory computer-readable medium described herein, the first signal indicates a selection for load balancing steering mode over the first access link and one or more other access links that are non-integrated in the wireless network.

A method for wireless communications by a first network entity is described. The method may include obtaining, from a UE, an indication that the UE supports a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network, outputting a first signal to the UE that indicates the UE is to use the first type of ATSSS for the PDU session with the wireless network via at least one of the first access link and the second access link, outputting, to a second network entity that provides a SMF, a second signal that indicates one or more policy charging and control (PCC) parameters for the PDU session with the UE including at least one of the first access link and the second access link, and outputting, to the second network entity that provides the SMF, an indication that the first signal indicating that the second access link is non-integrated in the wireless network has been sent to the UE.

A first network entity for wireless communications is described. The first network entity may include one or more memories storing processor executable code, and one or more processors coupled with the one or more memories. The one or more processors may individually or collectively be operable to execute the code to cause the first network entity to obtain, from a UE, an indication that the UE supports a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network, output a first signal to the UE that indicates the UE is to use the first type of ATSSS for the PDU session with the wireless network via at least one of the first access link and the second access link, output, to a second network entity that provides a SMF, a second signal that indicates one or more PCC parameters for the PDU session with the UE including at least one of the first access link and the second access link, and output, to the second network entity that provides the SMF, an indication that the first signal indicating that the second access link is non-integrated in the wireless network has been sent to the UE.

Another first network entity for wireless communications is described. The first network entity may include means for obtaining, from a UE, an indication that the UE supports a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network, means for outputting a first signal to the UE that indicates the UE is to use the first type of ATSSS for the PDU session with the wireless network via at least one of the first access link and the second access link, means for outputting, to a second network entity that provides a SMF, a second signal that indicates one or more PCC parameters for the PDU session with the UE including at least one of the first access link and the second access link, and means for outputting, to the second network entity that provides the SMF, an indication that the first signal indicating that the second access link is non-integrated in the wireless network has been sent to the UE.

A non-transitory computer-readable medium storing code for wireless communications is described. The code may include instructions executable by one or more processors to obtain, from a UE, an indication that the UE supports a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network, output a first signal to the UE that indicates the UE is to use the first type of ATSSS for the PDU session with the wireless network via at least one of the first access link and the second access link, output, to a second network entity that provides a SMF, a second signal that indicates one or more PCC parameters for the PDU session with the UE including at least one of the first access link and the second access link, and output, to the second network entity that provides the SMF, an indication that the first signal indicating that the second access link is non-integrated in the wireless network has been sent to the UE.

In some examples of the method, first network entities, and non-transitory computer-readable medium described herein, the first signal provides URSP rules that provide an indication that a preference for the PDU session is for the first access link associated with the wireless network and the second access link that is non-integrated in the wireless network. In some examples of the method, first network entities, and non-transitory computer-readable medium described herein, in an absence of the first signal that indicates a URSP for the second access link is non-integrated in the wireless network, one or more ATSSS rules associated with a second type of ATSSS including a PDU session in which both access links that are integrated in the wireless network are to be used. In some examples of the method, first network entities, and non-transitory computer-readable medium described herein, the first signal includes a set of bits having a value that is mapped to a route selection descriptor component type identifier associated with a PDU session in which the second access link is non-integrated in the wireless network.

In some examples of the method, first network entities, and non-transitory computer-readable medium described herein, the first network entity is a PCF.

A method for wireless communications by a second network entity is described. The method may include obtaining, from a first network entity, a signal that indicates one or more PCC parameters for a PDU session with a UE, the PDU session including at least one of a first access link and a second access link, obtaining, from the first network entity, an indication that a first signal indicating that the second access link is non-integrated in the wireless network has been sent to the UE, and outputting, to the UE and to a third network entity, a set of rules for a first type of ATSSS for the PDU session, where the first access link is associated with a first access technology corresponding to a wireless network and the second access link is associated with a second access technology different from the first access technology, and where the second access link is non-integrated in the wireless network.

A second network entity for wireless communications is described. The second network entity may include one or more memories storing processor executable code, and one or more processors coupled with the one or more memories. The one or more processors may individually or collectively be operable to execute the code to cause the second network entity to obtain, from a first network entity, a signal that indicates one or more PCC parameters for a PDU session with a UE, the PDU session including at least one of a first access link and a second access link, obtain, from the first network entity, an indication that a first signal indicating that the second access link is non-integrated in the wireless network has been sent to the UE, and output, to the UE and to a third network entity, a set of rules for a first type of ATSSS for the PDU session, where the first access link is associated with a first access technology corresponding to a wireless network and the second access link is associated with a second access technology different from the first access technology, and where the second access link is non-integrated in the wireless network.

Another second network entity for wireless communications is described. The second network entity may include means for obtaining, from a first network entity, a signal that indicates one or more PCC parameters for a PDU session with a UE, the PDU session including at least one of a first access link and a second access link, means for obtaining, from the first network entity, an indication that a first signal indicating that the second access link is non-integrated in the wireless network has been sent to the UE, and means for outputting, to the UE and to a third network entity, a set of rules for a first type of ATSSS for the PDU session, where the first access link is associated with a first access technology corresponding to a wireless network and the second access link is associated with a second access technology different from the first access technology, and where the second access link is non-integrated in the wireless network.

A non-transitory computer-readable medium storing code for wireless communications is described. The code may include instructions executable by one or more processors to obtain, from a first network entity, a signal that indicates one or more PCC parameters for a PDU session with a UE, the PDU session including at least one of a first access link and a second access link, obtain, from the first network entity, an indication that a first signal indicating that the second access link is non-integrated in the wireless network has been sent to the UE, and output, to the UE and to a third network entity, a set of rules for a first type of ATSSS for the PDU session, where the first access link is associated with a first access technology corresponding to a wireless network and the second access link is associated with a second access technology different from the first access technology, and where the second access link is non-integrated in the wireless network.

In some examples of the method, second network entities, and non-transitory computer-readable medium described herein, the set of ATSSS rules provide an indication that a preference for the PDU session is for the first access link associated with the wireless network and the second access link that is non-integrated in the wireless network.

In some examples of the method, second network entities, and non-transitory computer-readable medium described herein, in an absence of an indication that a first signal indicating that the second access link is non-integrated in the wireless network one or more rules associated with a second type of ATSSS including a PDU session in which both access links that are integrated in the wireless network are to be used.

In some examples of the method, second network entities, and non-transitory computer-readable medium described herein, the set of ATSSS rules indicates a selection for an active standby steering mode associated with the first access link and one or more other access links that are non-integrated in the wireless network. In some examples of the method, second network entities, and non-transitory computer-readable medium described herein, the set of ATSSS rules indicates a selection for a priority based steering mode associated with the first access link and one or more other access links that are non-integrated in the wireless network. In some examples of the method, second network entities, and non-transitory computer-readable medium described herein, the set of ATSSS rules indicates a selection for an RSM associated with the first access link and one or more other access links that are non-integrated in the wireless network. In some examples of the method, second network entities, and non-transitory computer-readable medium described herein, the set of ATSSS rules indicates a selection for an RSM associated with the first access link and one or more other access links that are non-integrated in the wireless network. In some examples of the method, second network entities, and non-transitory computer-readable medium described herein, the set of rules are ATSSS rules sent to the UE.

In some examples of the method, second network entities, and non-transitory computer-readable medium described herein, the set of rules are N4/Multi-Access-Rules (MAR) rules sent to a User Plane Function (UPF). In some examples of the method, second network entities, and non-transitory computer-readable medium described herein, the second network entity is a SMF.

A method for wireless communications by a third network entity of a wireless network is described. The method may include obtaining a signal that indicates a set of N4/MARs for a first type of ATSSS for a PDU session with a UE via a first access link and a second access link, where the first access link is associated with a first access technology corresponding to the wireless network and the second access link is associated with a second access technology different from the first access technology, and where the second access link is non-integrated in the wireless network and communicating with the UE via at least one of the first access link and the second access link based on the set of N4/MARs.

A third network entity of a wireless network for wireless communications is described. The third network entity of a wireless network may include one or more memories storing processor executable code, and one or more processors coupled with the one or more memories. The one or more processors may individually or collectively be operable to execute the code to cause the third network entity of a wireless network to obtain a signal that indicates a set of N4/MARs for a first type of ATSSS for a PDU session with a UE via a first access link and a second access link, where the first access link is associated with a first access technology corresponding to the wireless network and the second access link is associated with a second access technology different from the first access technology, and where the second access link is non-integrated in the wireless network and communicate with the UE via at least one of the first access link and the second access link based on the set of N4/MARs.

Another third network entity of a wireless network for wireless communications is described. The third network entity of a wireless network may include means for obtaining a signal that indicates a set of N4/MARs for a first type of ATSSS for a PDU session with a UE via a first access link and a second access link, where the first access link is associated with a first access technology corresponding to the wireless network and the second access link is associated with a second access technology different from the first access technology, and where the second access link is non-integrated in the wireless network and means for communicating with the UE via at least one of the first access link and the second access link based on the set of N4/MARs.

A non-transitory computer-readable medium storing code for wireless communications is described. The code may include instructions executable by one or more processors to obtain a signal that indicates a set of N4/MARs for a first type of ATSSS for a PDU session with a UE via a first access link and a second access link, where the first access link is associated with a first access technology corresponding to the wireless network and the second access link is associated with a second access technology different from the first access technology, and where the second access link is non-integrated in the wireless network and communicate with the UE via at least one of the first access link and the second access link based on the set of N4/MARs.

In some examples of the method, third networks entity of a wireless networks, and non-transitory computer-readable medium described herein, the set of N4/MARs indicates a selection for an active standby steering mode associated with the first access link and one or more other access links that are non-integrated in the wireless network. In some examples of the method, third networks entity of a wireless networks, and non-transitory computer-readable medium described herein, the set of N4/MARs indicates a selection for a priority based steering mode associated with the first access link and one or more other access links that are non-integrated in the wireless network. In some examples of the method, third networks entity of a wireless networks, and non-transitory computer-readable medium described herein, the set of N4/MARs indicates a selection for an RSM associated with the first access link and one or more other access links that are non-integrated in the wireless network.

In some examples of the method, third networks entity of a wireless networks, and non-transitory computer-readable medium described herein, the set of N4/MARs indicates a selection for a load balancing steering mode associated with the first access link and one or more other access links that are non-integrated in the wireless network. In some examples of the method, third networks entity of a wireless networks, and non-transitory computer-readable medium described herein, the third network entity is a UPF.

### BRIEF DESCRIPTION OF THE DRAWINGS

FIG. 1 shows an example of a wireless communications system that supports techniques for protocol data unit (PDU) sessions via multiple access networks in accordance with one or more aspects of the present disclosure.

FIG. 2 shows an example of a wireless communications system that supports techniques for PDU sessions via multiple access networks in accordance with one or more aspects of the present disclosure.

FIG. 3 shows an example of an ATSSS-Lite architecture that supports techniques for PDU sessions via multiple access networks in accordance with one or more aspects of the present disclosure.

FIG. 4 shows an example of a process flow that supports techniques for PDU sessions via multiple access networks in accordance with one or more aspects of the present disclosure.

FIGS. 5 and 6 show block diagrams of devices that support techniques for PDU sessions via multiple access networks in accordance with one or more aspects of the present disclosure.

FIG. 7 shows a block diagram of a communications manager that supports techniques for PDU sessions via multiple access networks in accordance with one or more aspects of the present disclosure.

FIG. 8 shows a diagram of a system including a device that supports techniques for PDU sessions via multiple access networks in accordance with one or more aspects of the present disclosure.

FIGS. 9 and 10 show block diagrams of devices that support techniques for PDU sessions via multiple access networks in accordance with one or more aspects of the present disclosure.

FIG. 11 shows a block diagram of a communications manager that supports techniques for PDU sessions via multiple access networks in accordance with one or more aspects of the present disclosure.

FIG. 12 shows a diagram of a system including a device that supports techniques for PDU sessions via multiple access networks in accordance with one or more aspects of the present disclosure.

FIGS. 13 through 16 show flowcharts illustrating methods that support techniques for PDU sessions via multiple access networks in accordance with one or more aspects of the present disclosure.

### DETAILED DESCRIPTION

Some wireless communications systems may support a protocol data unit (PDU) session for a user equipment (UE). For example, a 3rd Generation Partnership Project (3GPP) wireless network may support a multiple access (MA) PDU session with both a 3GPP access link (3GPPA) and a non-3GPP access link (N3GPPA) integrated in the 3GPP wireless network for the MA PDU session. It is noted that the terms “MA PDU session,” “PDU session,” and “session” may be used interchangeably herein. To support coordination and flexibility between the different access links, the wireless network may implement access traffic steering-switching-splitting (ATSSS) functionality. However, ATSSS may rely on integrated N3GPPA for communications, which may use a gateway or other network function to integrate the N3GPPA link within the 3GPP wireless network. ATSSS may fail to support non-integrated, non-3GPP access (NIN3A), potentially reducing the flexibility and increasing the overhead associated with ATSSS functionality.

In accordance with various aspects discussed herein, different types of ATSSS may support different types of N3PPA links. For example, a first type of ATSSS (e.g., referred to as “ATSSS-Lite”) may support an N3GPPA link that is not integrated in the 3GPP wireless network, that is, that it does not use a gateway or other network function to integrate with the 3GPP wireless network. A second type of ATSSS (e.g., referred to as “legacy ATSSS” or simply as “ATSSS”) may support an N3GPPA link that is integrated in the 3GPP wireless network. To provide both ATSSS and ATSSS-Lite functionality, a wireless communications system may support signaling and provide access and traffic steering modes that supports ATSSS and ATSSS-Lite capabilities.

In some aspects, a UE that is capable of ATSSS-Lite may receive a first signal that indicates the UE is to use NIN3A ATSSS for a PDU session with a wireless network using both a first access link associated with a 3GPP link (or an integrated non-3GPP link) and a second access link associated with an NIN3A link. The UE may establish the PDU session using the first access link, and may communicate with the wireless network via at least one of the first access link or the second access link based on the established PDU session. In some aspects, the PDU session may use extended URSP rules that apply to the PDU session with a 3GPPA link and an NIN3A link. In such aspects, rules related to ATSSS (e.g., N4 rules, such as rules for ATSSS functionality) may be unchanged relative to ATSSS rules that apply to PDU session with a 3GPPA link and an integrated N3GPPA link. In other aspects, the MA PDU session may use extended ATSSS/N4 rules that explicitly include 3GPPA and NIN3A combinations. In such aspects, URSP rules may be unchanged relative to URSP rules that apply to PDU session with a 3GPPA link and an N3GPPA link.

In some aspects, a 3GPPA link may use access technology corresponding to the wireless network and may be an example of Long Term Evolution (LTE), New Radio (NR), third generation (3G) technology, fourth generation (4G) technology, fifth generation (5G) technology, sixth generation (6G) technology, or any other 3GPP-related access technology, and N3GPPA technology may include wireless local area network (WLAN) technology, Wi-Fi, wired local area network (LAN) technology, or any other non-3GPP-related access technology.

Supporting ATSSS-Lite may improve signaling and data transfer flexibility between 3GPP and N3GPPA for the wireless network and may reduce user plane overhead associated with ATSSS functionality. In some examples, performing PDU session establishment for an NIN3A link may involve an improved processing and signaling overhead as compared to performing PDU session establishment for an integrated N3GPPA link (e.g., for ATSSS-Lite, PDU establishment is performed via the 3GPP link but not via the NIN3A link). Additionally, or alternatively, the wireless network may provide coordination for the coexistence of ATSSS and ATSSS-Lite functionality based on supporting capability information and network entity (e.g., session management function (SMF), user plane function (UPF)) selection that differentiate between ATSSS and ATSSS-Lite capabilities. The wireless network may effectively identify devices that support ATSSS or ATSSS-Lite and may configure PDU sessions that provide ATSSS or ATSSS-Lite functionality for the relevant devices.

Aspects of the disclosure are initially described in the context of wireless communications systems. Additional aspects of the disclosure are described with respect to network architectures and process flows. Aspects of the disclosure are further illustrated by and described with reference to apparatus diagrams, system diagrams, and flowcharts that relate to techniques for MA PDU sessions via multiple access networks.

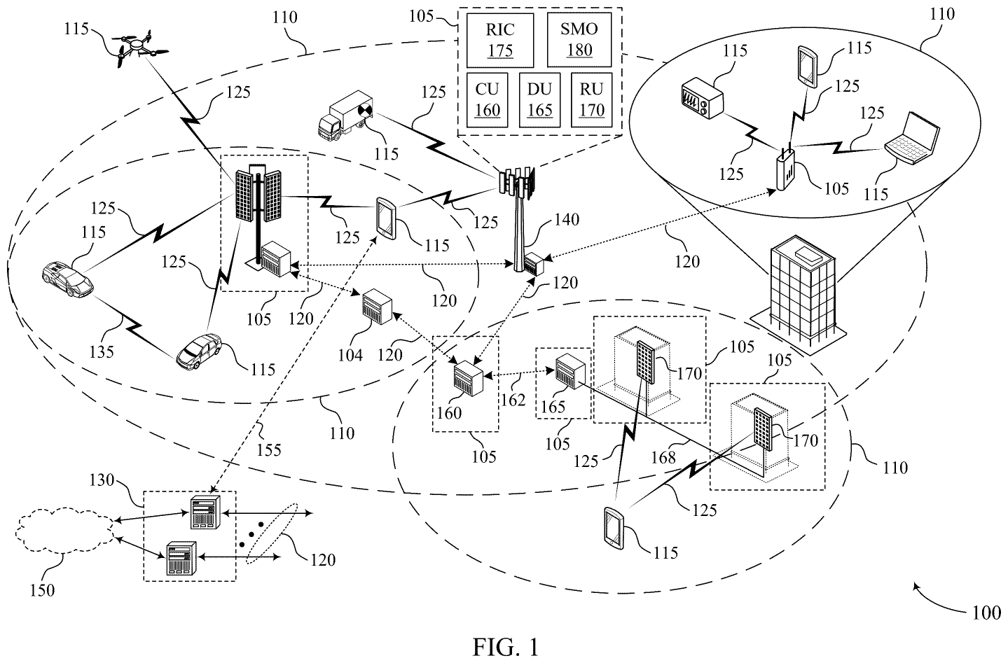

FIG. 1 shows an example of a wireless communications system 100 that supports techniques for MA PDU sessions via multiple access networks in accordance with one or more aspects of the present disclosure. The wireless communications system 100 may include one or more devices, such as one or more network devices (e.g., network entities 105), one or more UEs 115, and a core network 130. In some examples, the wireless communications system 100 may be an LTE network, an LTE-Advanced (LTE-A) network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a UPF). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support ATSSS functionality. ATSSS may involve traffic steering, switching, and splitting between a first access technology and a second access technology. The wireless network of the wireless communications system 100 may establish an MA PDU session with a UE 115 including at least a first access link associated with the first access technology and a second access link associated with the second access technology. For example, the MA PDU session may connect the UE 115 to the core network 130 of the wireless network via different access technologies. In some examples, the first access technology may correspond to the wireless network (e.g., the first access technology may be an example of a 3GPP RAT, such as 3G, 4G, 5G, 6G, or some other 3GPP technology). The second access technology may be different from the first access technology (e.g., the second access technology may be an example of an N3GPPA technology, such as WLAN, Wi-Fi, a wired network, or some other non-3GPP technology).

The wireless network may support data communications via the first access link, the second access link, or both. For example, for ATSSS, the wireless network may support “steering” of data communications for the UE 115 by selecting which access link to use for the data communications (e.g., based on quality of service (Qos), channel strength, or channel quality metrics). Additionally, or alternatively, the wireless network may support “switching” between the first access link associated with the first access technology and the second access link associated with the second access technology without an interruption of service for the UE 115. Additionally, or alternatively, the wireless network may support “splitting” data communications, such that the UE 115 and the wireless network may communicate via at least the first access link and the second access link concurrently.

In some examples, ATSSS may include trusted or untrusted connectivity of a non-3GPP technology integrated with the core network 130 of the wireless communications system 100. For example, the wireless communications system 100 may include a non-3GPP inter-working function (N3IWF), a trusted non-3GPP gateway function (TNGF), a trusted WLAN inter-working function (TWIF), or some combination of these or other functions that integrate N3GPPA into the 3GPP wireless network of the wireless communications system 100. Accordingly, an MA PDU session supporting ATSSS may include a 3GPPA link and at least one integrated (e.g., integrated with the 3GPP wireless network via one or more functions or gateways) N3GPPA link.

In contrast to ATSSS, some wireless communications systems 100 may support ATSSS-Lite functionality, which may include an NIN3A link to the core network 130 of the wireless network. For example, the wireless communications system 100 may support a non-3GPP (e.g., WLAN, Wi-Fi, ethernet) access link without an N3IWF, TNGF, TWIF, or other network function or gateway integrating the N3GPPA into the architecture of the 3GPP wireless network. Such an access link may be referred to as non-integrated in the wireless network. In some cases, the wireless network may communicate this NIN3A traffic via the Internet. ATSSS-Lite may simplify operations via the N3GPPA link without compromising the security of the 3GPP wireless network. For example, ATSSS-Lite may protect the confidentiality and integrity of messages sent between a UE 115 and a UPF of the wireless network via the NIN3A link by using a transport layer security (TLS) connection, for example. ATSSS-Lite functionality may be based on, or similar to, multipath quick user datagram protocol internet connections (MPQUIC) or multipath transmission control protocol (MPTCP) functionality (e.g., for steering, switching, splitting, or some combination thereof). In some examples, ATSSS-Lite may improve signaling flexibility between 3GPP and N3GPPA, reduce user plane overhead, simplify the protocol stack, or some combination thereof.

In some examples, to support communications in accordance with ATSSS-Lite functionality, the wireless communications system 100 may support URSP rules and/or ATSSS rules for ATSSS-Lite communications. For example, a UE 115 may receive signaling that may indicate extended URSP rules so that ATSSS/N4 rules, instead of applying to 3GPPA+N3GPPA, apply to 3GPPA+NIN3A. In such examples, no changes may be provided to ATSSS/N4 rules associated with 3GPPA+N3GPPA. In other examples, ATSSS/N4 rules may be extended to explicitly include 3GPPA+NIN3A combinations. Such examples allow for no changes to URSP rules relative to 3GPPA+N3GPPA URSP rules. In aspects that include extended URSP rules, the indication may include explicit indication that Multi-Access preference is with 3GPPA+NIN3A, or if the new indication is not included, ATSSS/N4 rules apply to 3GPPA+N3GPPA (e.g., legacy behavior), and if a new indication is used, ATSSS/N4 rules implicitly apply to 3GPPA+NIN3A (e.g., instead of to 3GPPA+N3GPPA). In aspects that include extended ATSSS/N4 rules, additional combinations may be provided for active-standby rules, priority based route selection rules, redundant steering mode (RSM) rules, load balancing rules, or any combination thereof.

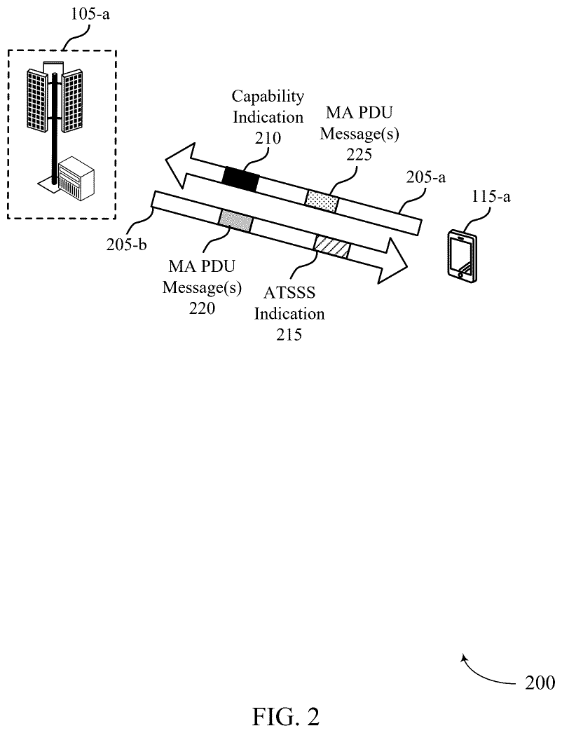

FIG. 2 shows an example of a wireless communications system 200 that supports techniques for PDU sessions via multiple access networks in accordance with one or more aspects of the present disclosure. The wireless communications system 200 may be an example of a wireless communications system 100 as described with reference to FIG. 1. The wireless communications system 200 may include a UE 115-a, which may be an example of a UE 115 as described with reference to FIG. 1, and a network entity 105-a, which may be an example of a network entity 105, a CU, a DU, an RU, or any combination thereof, as described with reference to FIG. 1. The UE 115-a and network entity 105-a may communicate via one or more access links 205 that may include an uplink channel 205-a and a downlink channel 205-b. The network entity 105-a may support an AMF, an SMF, a UPF, a policy control function (PCF), or any combination thereof for a 3GPP wireless network. Additionally, or alternatively, the wireless communications system 200 may include multiple network entities 105 supporting different network functionality. For example, separate network entities 105 may operate as an AMF, an SMF, a UPF, and a PCF, or a single network entity 105 may perform operations associated with more than one of the AMF, the SMF, the UPF, and the PCF for the 3GPP wireless network. The wireless communications system 200 may support signaling for establishing an ATSSS-Lite session for the UE 115-a.

The wireless communications system 200 may support separate capability information associated with ATSSS-Lite and ATSSS (e.g., legacy ATSSS) functionality. For example, UEs 115 and network entities 105 may be capable of supporting ATSSS (e.g., with an integrated N3GPPA link), ATSSS-Lite (e.g., with an NIN3A link), both, or neither. The UE 115-a may signal such capabilities independently. For example, the UE 115-a may provide a capability indication 210 to indicate, to the wireless network, an ATSSS-Lite capability, an ATSSS capability, both, or neither.

In some examples, the network entity 105-a may transmit, to the UE 115-a, a message that provides an ATSSS indication 215 that indicates that the UE 115-a is to use a first type of ATSSS. In some aspects, the first type of ATSSS may include a PDU session using both a first access link and a second access link, in which the first access link is associated with a first access technology (e.g., 3GPPA or N3GPPA) and the second access link is associated with a second access technology (e.g., NIN3A) that is different from the first access technology. The UE 115-a and network entity 105-a may establish the PDU session via both the first access link and the second access link, and exchange downlink PDU messages 220 and uplink PDU messages 225.

In some aspects, to support communications in accordance with ATSSS-Lite functionality, URSP rules may be extended so that ATSSS/N4 rules, instead of applying to 3GPPA+N3GPPA, apply to 3GPPA+NIN3A. In such aspects, the same ATSSS/N4 rules may be applied for both 3GPPA+N3GPPA and 3GPPA+NIN3A. In other aspects, to support communications in accordance with ATSSS-Lite functionality, ATSSS/N4 rules may be extended to explicitly include 3GPPA+NIN3A combinations. In such aspects, the same URSP rules may be applied for both 3GPPA+N3GPPA and 3GPPA+NIN3A.

In aspects that provide for extended URSP rules, the URSP rules may be extended relative to 3GPPA+N3GPPA rules to include an explicit indication that a multi-access preference is with 3GPPA+NIN3A. In some cases, if this new indication is not included, ATSSS/N4 rules apply to 3GPPA+N3GPPA (e.g., legacy behavior), and if the new indication is included, ATSSS/N4 rules implicitly apply to 3GPPA+NIN3A (e.g., instead of to 3GPPA+N3GPPA). In some aspects, a route selection descriptor component type identifier may be provided that indicates multi-access with an NIN3A preference type. An example of a set of route selection descriptor component type identifiers and associated mapping is provided below, in which the bit value 00010010 indicates the NIN3A preference type.

Route selection descriptor component type identifier Bits

| 8 | 7 | 6 | 5 | 4 | 3 | 2 | 1 | |
|---|---|---|---|---|---|---|---|---|
| 0 | 0 | 0 | 0 | 0 | 0 | 0 | 1 | SSC mode type |
| 0 | 0 | 0 | 0 | 0 | 0 | 1 | 0 | S-NSSAI type |
| 0 | 0 | 0 | 0 | 0 | 1 | 0 | 0 | DNN type |
| 0 | 0 | 0 | 0 | 1 | 0 | 0 | 0 | PDU session type type |
| 0 | 0 | 0 | 1 | 0 | 0 | 0 | 0 | Preferred access type type (Note 2) |
| 0 | 0 | 0 | 1 | 0 | 0 | 0 | 1 | Multi-access preference type (Note 2) |
| 0 | 0 | 0 | 1 | 0 | 0 | 1 | 0 | Multi-access with NIN3A preference type (Note X) |
| 0 | 0 | 1 | 0 | 0 | 0 | 0 | 0 | Non-seamless non-3GPP offload indication type (Note 9) |
| 0 | 1 | 0 | 0 | 0 | 0 | 0 | 0 | Location criteria type |
| 1 | 0 | 0 | 0 | 0 | 0 | 0 | 0 | Time window type |
| 1 | 0 | 0 | 0 | 0 | 0 | 0 | 1 | 5G ProSe layer-3 UE-to-network relay offload indication |
| type (Note 9) | | | | | | | | |
| 1 | 0 | 0 | 0 | 0 | 0 | 1 | 0 | PDU session pair ID type (Note 5, Note 9) |
| 1 | 0 | 0 | 0 | 0 | 0 | 1 | 1 | RSN type (Note 5, Note 9) |
| 1 | 0 | 0 | 0 | 0 | 1 | 0 | 0 | 5G ProSe multi-path preference type |

All other values are spare. If received they shall be interpreted as unknown.
[. . .]
NOTE X:
The PCF includes only one among “preferred access type type”, “multi-access preference type” and “multi-access with NIN3A preference type” route selection descriptor components in a single route selection descriptor. If there are both “preferred access type type” and “multi-access preference type” route selection descriptor components in a single route selection descriptor, the UE ignores the “preferred access type type” route selection descriptor component. If there are both “multi-access with NIN3A preference type” and “multi-access preference type” or “multi-access with NIN3A preference type” and “preferred access type type” route selection descriptor components in a single route selection descriptor, the UE considers only the “multi-access with NIN3A preference type” ignores the others.

In aspects that provide for extended ATSSS/N4 rules, the ATSSS rules may be extended relative to 3GPPA+N3GPPA rules. In some aspects, the ATSSS rules may include rules for Active-standby, priority based, shortest delay, and RSM. In some aspects, active standby rules may include:
Existing Active-standby rules:
   1. Active 3GPP and no standby
   2. Active 3GPP and non-3GPP standby
   3. Active non-3GPP and no standby
   4. Active non-3GPP and 3GPP standby
which may be extended to include additional combinations:
   5. Active 3GPP and NIN3A standby
   6. Active NIN3A and no standby
   7. Active NIN3A and 3GPP standby.

In some aspects, priority based rules may include:
Existing priority based rules:
   1. 3GPP is high priority access
   2. non-3GPP is high priority access
which may be extended to include additional combination:
   3. NIN3A is high priority access.

In some aspects, shortest delay rules may include a rule to use the access with the shortest round trip time (RTT), which may also apply to 3GPPA+NIN3A. In some aspects, RSM rules may include:
Existing RSM rules:
   1. Duplicate traffic over both access. In case of RTT/PLR threshold, a primary access (3GPP or non-3GPP) can be indicated
which may be extended to include additional combination:
   2. Indicate NIN3A as primary access.

In some aspects, load balancing rules may include:
Existing Load balancing combinations:
   1. 100% over 3GPP and 0% over non-3GPP
   2. 90% over 3GPP and 10% over non-3GPP
   3. 80% over 3GPP and 20% over non-3GPP
   4. 70% over 3GPP and 30% over non-3GPP
   5. 60% over 3GPP and 40% over non-3GPP
   6. 50% over 3GPP and 50% over non-3GPP
   7. 40% over 3GPP and 60% over non-3GPP
   8. 30% over 3GPP and 70% over non-3GPP
   9. 20% over 3GPP and 80% over non-3GPP
   10. 10% over 3GPP and 90% over non-3GPP
   11. 0% over 3GPP and 100% over non-3GPP
which may be extended to include additional combinations:
   12. 100% over 3GPP and 0% over NIN3A
   13. 90% over 3GPP and 10% over NIN3A
   14. 80% over 3GPP and 20% over NIN3A
   15. 70% over 3GPP and 30% over NIN3A
   16. 60% over 3GPP and 40% over NIN3A
   17. 50% over 3GPP and 50% over NIN3A
   18. 40% over 3GPP and 60% over NIN3A
   19. 30% over 3GPP and 70% over NIN3A
   20. 20% over 3GPP and 80% over NIN3A
   21. 10% over 3GPP and 90% over NIN3A
   22. 0% over 3GPP and 100% over NIN3A

Using such techniques new encoding possibilities are provided for steering mode information to enable the usage of steering modes with NIN3A.

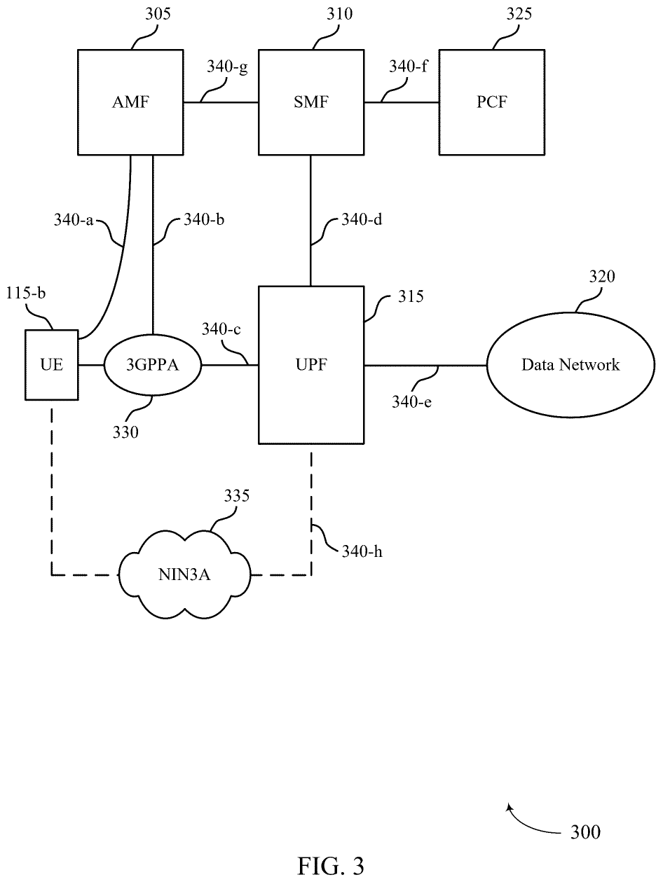

FIG. 3 shows an example of an ATSSS-Lite architecture 300 that supports techniques for PDU sessions via multiple access networks in accordance with one or more aspects of the present disclosure. The ATSSS-Lite architecture 300 may be an example of a wireless communications system 100 or 200, as described with reference to FIGS. 1 and 2. The ATSSS-Lite architecture 300 may include a UE 115-b, which may be an example of a UE 115 as described with reference to FIGS. 1 and 2. The ATSSS-Lite architecture 300 may additionally include one or more network entities 105, which may be examples of CUs, DUs, RUs, or any combination thereof, as described with reference to FIGS. 1 and 2. One or more network entities 105 may support an AMF 305, an SMF 310, a UPF 315, a data network 320 (e.g., which may be an example of a core network 130 as described with reference to FIG. 1), a PCF 325, or any combination thereof. The ATSSS-Lite architecture 300 may support communications via 3GPPA 330 and via NIN3A 335. For example, the NIN3A 335 may be via an IP network (e.g., Wi-Fi, LAN, or other IP access) that is not integrated (non-integrated) in, or otherwise external to, the 3GPP wireless network. NIN3A may be an example of a non-3GPP network connected directly with a UPF 315 of a 3GPP network (e.g., via a gateless or 3GPP network function-free connection).

In some aspects, to establish an ATSSS-Lite connection (e.g., an MA PDU session with a 3GPPA 330 link and at least one NIN3A 335 link), the UE 115-b may transmit an NAS message to the AMF 305 via a first interface 340-a (e.g., an N1 interface). The NAS message may include, or be an example of, a PDU session establishment message and may indicate that the UE 115-b is capable of supporting ATSSS-Lite. The ATSSS-Lite capability indication for the UE 115-b may be visible or transparent to the AMF 305. For example, in some cases, the AMF 305 may support procedures to handle an ATSSS-Lite capability indication, while in some other cases, the AMF 305 may operate according to procedures for handling an ATSSS (e.g., legacy ATSSS) capability indication.

The AMF 305 may select (e.g., determine, identify, connect via) an SMF 310 via an interface 340-g (e.g., an N11 interface) for the PDU session of the UE 115-b. The selected SMF 310 may support ATSSS-Lite. For example, the AMF 305 may select the specific SMF 310 based on the SMF 310 supporting ATSSS-Lite, or the AMF 305 may select an SMF 310 based on the SMF 310 supporting ATSSS, and the selected SMF 310 may additionally support ATSSS-Lite. The selected SMF 310 may in turn select (e.g., determine, identify, connect via) a UPF 315, a PCF 325, or both. The SMF 310 may select the UPF 315 via an interface 340-d (e.g., an N4 interface), the PCF 325 via an interface 340-f (e.g., an N7 interface), or both. The SMF 310 may select a UPF 315 that supports ATSSS-Lite. For example, the SMF 310 may select the specific UPF 315 based on the UPF 315 supporting ATSSS-Lite (e.g., supporting both the 3GPPA 330 and the NIN3A 335). For example, a UPF 315 configured to communicate traffic via an interface 340-h (e.g., an Nx interface) may support ATSSS-Lite.

The SMF 310 may establish the 3GPP portion of the MA PDU session for the UE 115-b via the selected UPF 315. For example, the UE 115-b may communicate with the SMF 310 (e.g., via the AMF 305) via an interface 340-b (e.g., an N2 interface) and may communicate with the UPF 315 via an interface 340-c (e.g., an N3 interface) using the 3GPPA 330. The UPF 315 may connect the UE 115-a with the data network 320 (e.g., the core network) via an interface 340-e (e.g., an N6 interface). Additionally, the UE 115-b may communicate with the UPF 315 via the interface 340-h (e.g., an Nx interface) using the NIN3A 335. The interface 340-h (e.g., the Nx interface) may be an interface defined for NIN3A to the UPF 315 and may be similar to the interface 340-c (e.g., the N6 interface). Accordingly, for ATSSS-Lite, the UPF 315 may support data communication between the UE 115-b and the data network 320 via 3GPPA 330, via NIN3A 335, or both (e.g., concurrently) based on ATSSS-Lite procedures.

In accordance with various aspects discussed herein, the PCF 325 may provide extended or new URSP rules to the UE 115-b in cases where URSP rules are extended to support NIN3A. Further, the PCF 325 may provide new policy charging and control (PCC) rules to the SMF 310 to cover usage of 3GPPA+NIN3A for PDU sessions. In some aspects, the SMF 310 may receive the PCC rules from PCF 325 and provides ATSSS/N4 rules (e.g., including extended or new rules to support NIN3A) to the UE 115-b and UPF 315 in cases where ATSSS rules are extended to support NIN3A. In some aspects, the UPF 315 may receive the N4 rules from the SMF 310 in cases where ATSSS rules are extended to support NIN3A, to handle traffic over 3GPPA+NIN3A. In some aspects, when URSP rules are extended to support NIN3A, the UE 115-b may receive the URSP rules (e.g., including extended or new rules to support NIN3A) from the PCF 325 and apply ATSSS rules to 3GPPA+NIN3A (e.g., instead of 3GPPA+N3GPPA). In other aspects, when ATSSS rules are extended to support NIN3A, the UE 115-b may receive ATSSS rules (e.g., including extended or new rules to support NIN3A) from the SMF 310 that indicate how the UE 115-b is to handle traffic over 3GPPA+NIN3A.

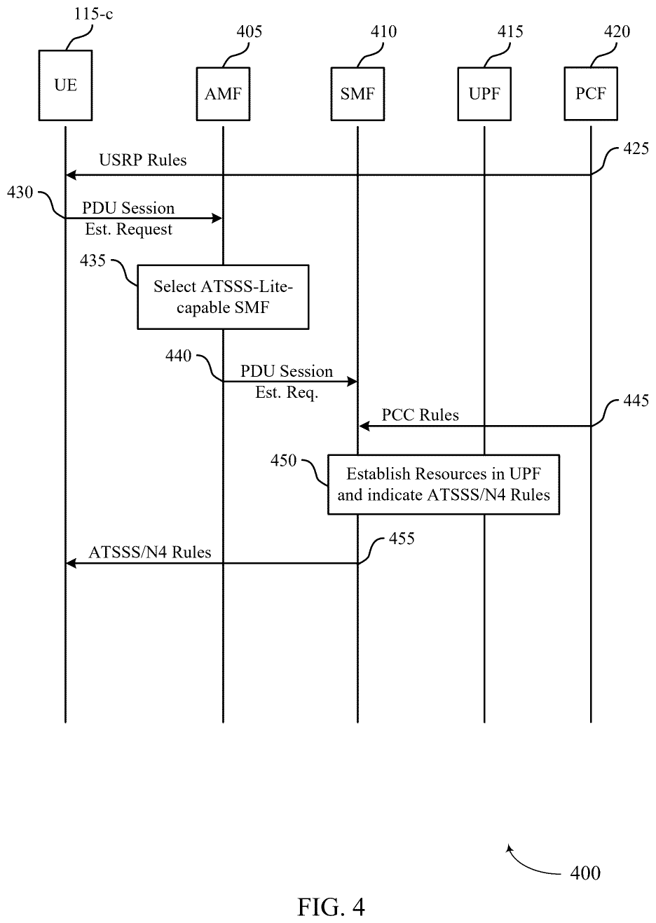

FIG. 4 shows an example of a process flow 400 that supports techniques for PDU sessions via multiple access networks in accordance with one or more aspects of the present disclosure. In some cases, aspects of the process flow 400 may implement or be implemented by aspects of a wireless communications system 100 or 200, or an ATSSS-Lite architecture 300, as described with reference to FIGS. 1 through 3. For example, the process flow 400 may include a UE 115-c, which may be an example of a UE 115 as described with reference to FIGS. 1 through 3. Additionally, the process flow 400 may include an AMF 405, an SMF 410, a UPF 415, and a PCF 420, which may be examples of an AMF, an SMF, a UPF, a PCF, a network entity 105, a CU, a DU, an RU, or any combination thereof as described with reference to FIGS. 1 through 3. For example, a first network entity 105 may be associated with the AMF 405, a second network entity 105 may be associated with the SMF 410, a third network entity 105 may be associated with the UPF 415, and a fourth network entity 105 may be associated with PCF 420. The first, second, third, and fourth network entities may be the same or different network entities. The AMF 405, the SMF 410, the UPF 415, and the PCF 420 may be associated with a wireless network, such as a 3GPP wireless network. The UE 115-c may indicate an ATSSS-Lite capability of the UE 115-c to support ATSSS-Lite session establishment, and may receive an indication of one or more extended URSP rules that support ATSSS-Lite.

In the following description of the process flow 400, the operations may be performed in a different order than the order shown. Additionally, or alternatively, other operations may be added or removed from the process flow 400. Although the UE 115-c, the AMF 405, the SMF 410, the UPF 415, and the PCF 420 are shown performing the operations of the process flow 400, some aspects of some operations may be performed by one or more other devices (e.g., other UEs 115, other network entities 105, or other entities external to the network, such as non-integrated entities).

At 425 the PCF 420 may transmit URSP rules to the UE 115-c. In some cases, the URSP rules initially may be provided prior to establishment of a PDU session. At 430, the UE 115-c may transmit a PDU session request to the AMF 405. In some aspects, the request from the UE 115-c may be encapsulated into an NAS message for the AMF 405.

At 435, the AMF 405 may select an ATSSS-Lite capable SMF 410 based on a ATSSS-Lite capability indication for the UE 115-c. For example, the UE 115-c may include the ATSSS-Lite capability indication in a portion of the NAS message that is processed (e.g., decoded, decrypted, otherwise read) by the AMF 405. The AMF 405 may determine the ATSSS-Lite capability indication for the UE 115-c and may select the SMF 410 based on the ATSSS-Lite capability indication for the UE 115-c. In some examples, the wireless network may support a network repository function (NRF) that tracks which SMFs are capable of ATSSS-Lite, which SMFs are capable of ATSSS, which UPFs are capable of ATSSS-Lite, which UPFs are capable of ATSSS, or some combination thereof. The AMF 405 may query the NRF using the ATSSS-Lite capability indication for the UE 115-c, and the NRF may respond to the query with SMF information (e.g., indicating one or more SMFs) supporting ATSSS-Lite. The AMF 405 may select a network entity associated with the SMF 410 capable of supporting ATSSS-Lite based on the NRF's response to the query. At 440, the AMF 405 may forward the PDU session establishment request to the selected SMF 410. For example, the first network entity associated with the AMF 405 may transmit the PDU session establishment request message (e.g., including an MA PDU session request) and the ATSSS-Lite capability indication for the UE 115-c to the second network entity associated with the SMF 410.

At 445, the PCF 420 may indicate, to the SMF 410, the one or more rules (e.g., URSP rules that support ATSSS-Lite functionality). At 450, the SMF 410 may establish user plane resources in the selected UPF 415 and may indicate one or more rules (e.g., N4 rules that may be a same set of rules for 3GPPA+N3GPPA and 3GPPA+NIN3A) to the selected UPF 415 for the requested PDU session. At 455, in some aspects, the SMF 410 may indicate, to the UE 115-c, the one or more ATSSS rules (e.g., ATSSS/N4 rules for 3GPPA+NIN3A that may be a different set of rules than for 3GPPA+N3GPPA).

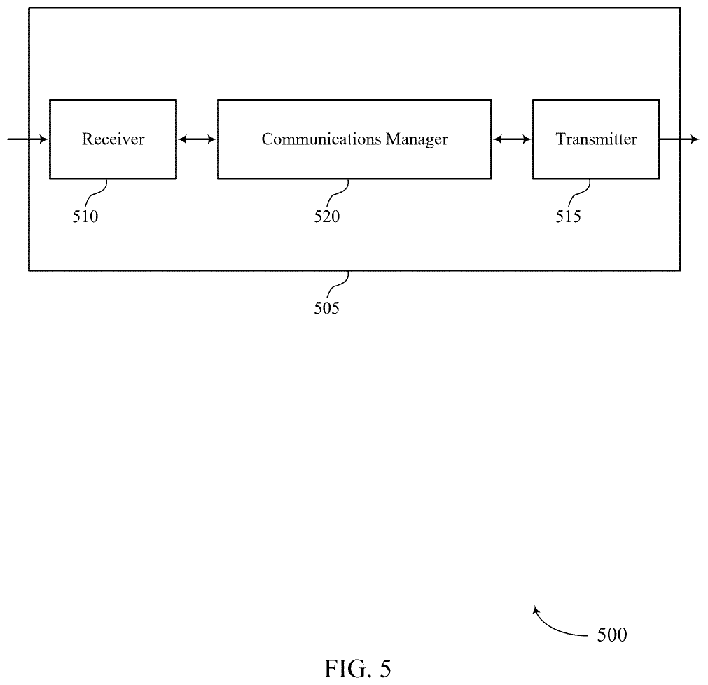

FIG. 5 shows a block diagram 500 of a device 505 that supports techniques for PDU sessions via multiple access networks in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for PDU sessions via multiple access networks). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for PDU sessions via multiple access networks). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for PDU sessions via multiple access networks as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a first signal that indicates that the UE is to use a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network. The communications manager 520 is capable of, configured to, or operable to support a means for establishing the PDU session with the wireless network via both the first access link and the second access link based on the first signal. The communications manager 520 is capable of, configured to, or operable to support a means for communicating with the wireless network via at least one of the first access link or the second access link based on the established PDU session.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for improving a processing overhead associated with a PDU session. For example, the device 505 may receive signaling that supports ATSSS-Lite, such that the wireless network establishes the PDU session with a 3GPP access link and an NIN3A link. Using ATSSS-Lite to communicate using both the 3GPP access link and the NIN3A link may improve communication reliability and throughput, reducing communication latency and processing overhead associated with retransmissions.

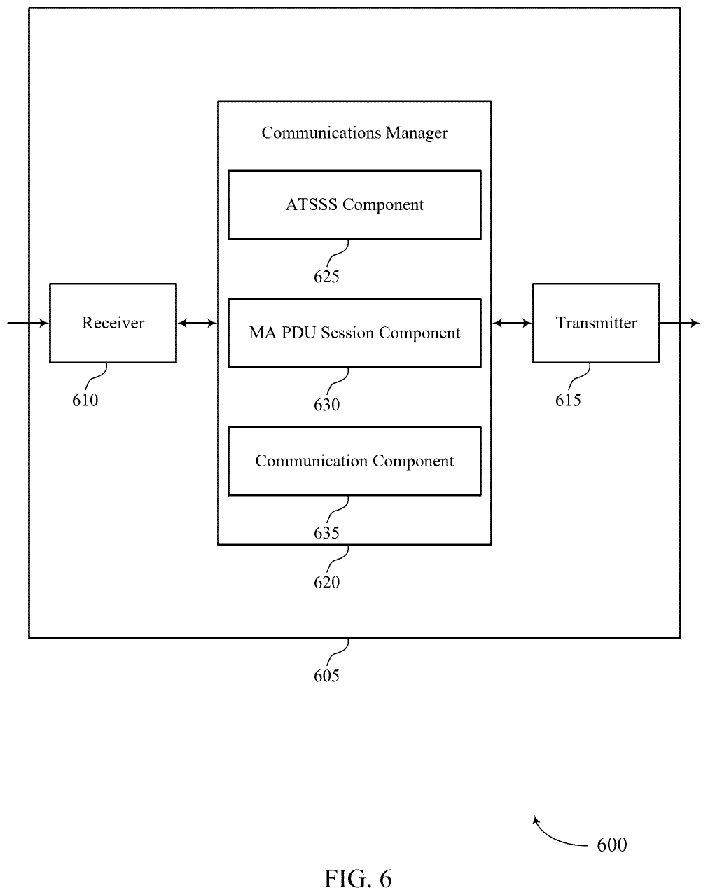

FIG. 6 shows a block diagram 600 of a device 605 that supports techniques for PDU sessions via multiple access networks in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for PDU sessions via multiple access networks). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for PDU sessions via multiple access networks). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for PDU sessions via multiple access networks as described herein. For example, the communications manager 620 may include an ATSSS component 625, a MA PDU session component 630, a communication component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The ATSSS component 625 is capable of, configured to, or operable to support a means for receiving a first signal that indicates that the UE is to use a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network. The MA PDU session component 630 is capable of, configured to, or operable to support a means for establishing the PDU session with the wireless network via both the first access link and the second access link based on the first signal. The communication component 635 is capable of, configured to, or operable to support a means for communicating with the wireless network via at least one of the first access link or the second access link based on the established PDU session.

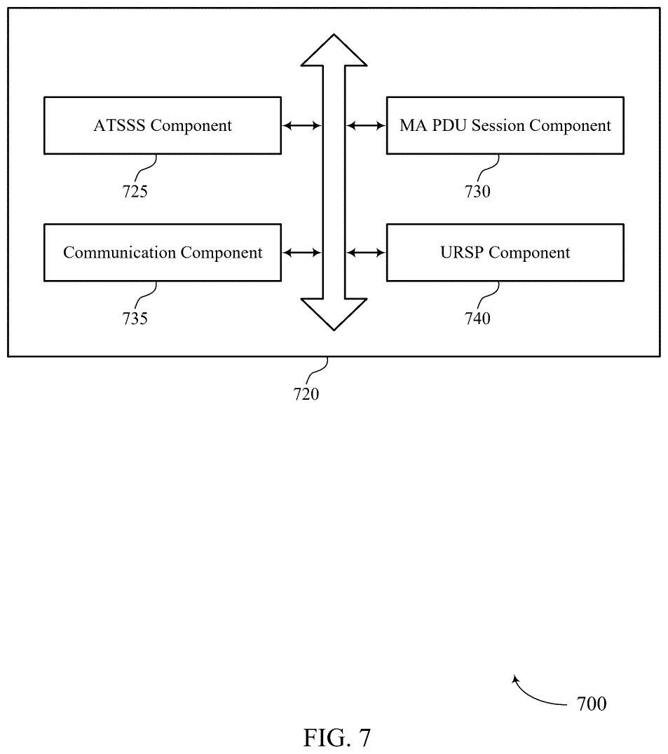

FIG. 7 shows a block diagram 700 of a communications manager 720 that supports techniques for PDU sessions via multiple access networks in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for PDU sessions via multiple access networks as described herein. For example, the communications manager 720 may include an ATSSS component 725, a MA PDU session component 730, a communication component 735, an URSP component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The ATSSS component 725 is capable of, configured to, or operable to support a means for receiving a first signal that indicates that the UE is to use a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network. The MA PDU session component 730 is capable of, configured to, or operable to support a means for establishing the PDU session with the wireless network via both the first access link and the second access link based on the first signal. The communication component 735 is capable of, configured to, or operable to support a means for communicating with the wireless network via at least one of the first access link or the second access link based on the established PDU session.

In some examples, to support receiving the first signal, the ATSSS component 725 is capable of, configured to, or operable to support a means for receiving the first signal from a PCF of the wireless network, where the first signal provides a URSP rule, and where the communicating with the wireless network is based on applying ATSSS rules associated with access links that are integrated to the wireless network to a first integrated access link together with a second non-integrated access link.

In some examples, to support receiving the first signal, the ATSSS component 725 is capable of, configured to, or operable to support a means for receiving the first signal from a SMF of the wireless network that provides a set of ATSSS rules for the first type of ATSSS for the PDU session, where the set of ATSSS rules are for access links that are non-integrated in the wireless network.

In some examples, the first signal provides URSP rules that provide an indication that a preference for the PDU session is for the first access link associated with the wireless network and the second access link that is non-integrated in the wireless network. In some examples, the UE, in an absence of the first signal that indicates a URSP for the second access link that is non-integrated in the wireless network, is to use a second type of ATSSS including a PDU session with the wireless network in which both access links are integrated in the wireless network, and the communicating with the wireless network uses, for both the first access link and the second access link, ATSSS rules that are associated with the second type of ATSSS.

In some examples, the first signal implicitly indicates that the second access link is non-integrated in the wireless network. In some examples, the first signal includes a set of bits having a value that is mapped to a route selection descriptor component type identifier associated with a PDU session in which the second access link is non-integrated in the wireless network. In some examples, the first signal indicates a selection for an active standby steering mode associated with the first access link and one or more other access links that are non-integrated in the wireless network. In some examples, the first signal indicates a selection for a priority based steering mode associated with the first access link and one or more other access links that are non-integrated in the wireless network. In some examples, the first signal indicates a selection for an RSM associated with the first access link and one or more other access links that are non-integrated in the wireless network. In some examples, the first signal indicates a selection for load balancing steering mode over the first access link and one or more other access links that are non-integrated in the wireless network.

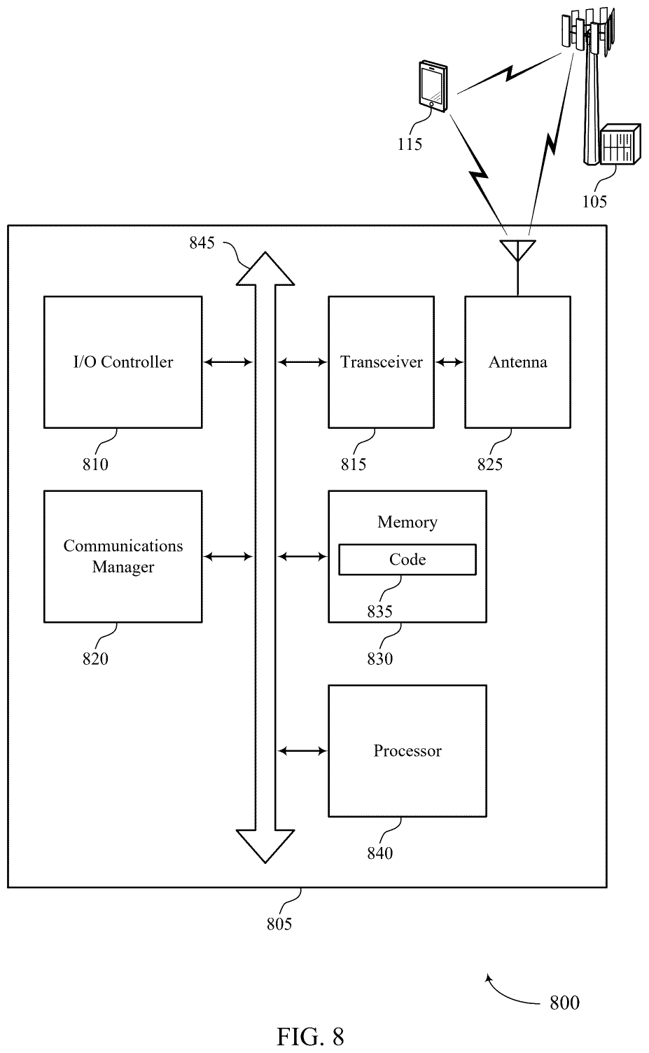

FIG. 8 shows a diagram of a system 800 including a device 805 that supports techniques for PDU sessions via multiple access networks in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for PDU sessions via multiple access networks). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a first signal that indicates that the UE is to use a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network. The communications manager 820 is capable of, configured to, or operable to support a means for establishing the PDU session with the wireless network via both the first access link and the second access link based on the first signal. The communications manager 820 is capable of, configured to, or operable to support a means for communicating with the wireless network via at least one of the first access link or the second access link based on the established PDU session.

By including or configuring the communications manager 820 in accordance with examples as described herein, the device 805 may support techniques for improving a processing overhead associated with a PDU session. For example, the device 805 may receive signaling that supports ATSSS-Lite, such that the wireless network establishes the PDU session with a 3GPP access link and an NIN3A link. Using ATSSS-Lite to communicate using both the 3GPP access link and the NIN3A link may improve communication reliability and throughput, reducing communication latency and processing overhead associated with retransmissions.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for PDU sessions via multiple access networks as described herein, or the at least one processor 840 and the at least one memory 830 may be otherwise configured to, individually or collectively, perform or support such operations.

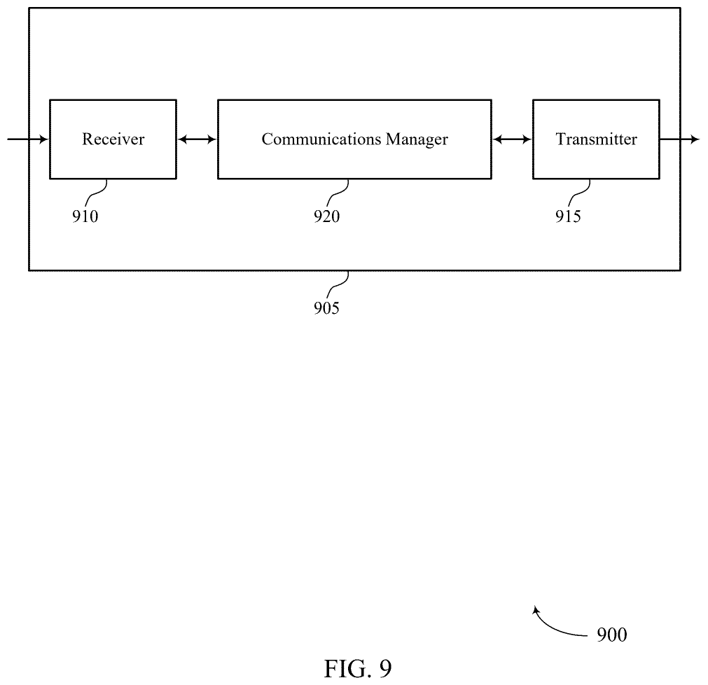

FIG. 9 shows a block diagram 900 of a device 905 that supports techniques for PDU sessions via multiple access networks in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, PDUs, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, PDUs, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for PDU sessions via multiple access networks as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for obtaining, from a UE, an indication that the UE supports a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network. The communications manager 920 is capable of, configured to, or operable to support a means for outputting a first signal to the UE that provides a URSP that indicates the UE is to use the first type of ATSSS for the PDU session with the wireless network via at least one of the first access link and the second access link. The communications manager 920 is capable of, configured to, or operable to support a means for outputting, to a second network entity that provides a SMF, a second signal that indicates one or more PCC parameters for the PDU session with the UE including at least one of the first access link and the second access link.

Additionally, or alternatively, the communications manager 920 may support wireless communications in accordance with examples as disclosed herein. For example, the communications manager 920 is capable of, configured to, or operable to support a means for obtaining, from a first network entity, a signal that indicates one or more PCC parameters for a PDU session with a UE, the PDU session including at least one of a first access link and a second access link. The communications manager 920 is capable of, configured to, or operable to support a means for outputting, to the UE and to a third network entity, a set of ATSSS rules for a first type of ATSSS for the PDU session, where the first access link is associated with a first access technology corresponding to a wireless network and the second access link is associated with a second access technology different from the first access technology, and where the second access link is non-integrated in the wireless network.

Additionally, or alternatively, the communications manager 920 may support wireless communications in accordance with examples as disclosed herein. For example, the communications manager 920 is capable of, configured to, or operable to support a means for obtaining a signal that indicates a set of ATSSS rules for a first type of ATSSS for a PDU session with a UE via a first access link and a second access link, where the first access link is associated with a first access technology corresponding to the wireless network and the second access link is associated with a second access technology different from the first access technology, and where the second access link is non-integrated in the wireless network. The communications manager 920 is capable of, configured to, or operable to support a means for communicating with the UE via at least one of the first access link and the second access link based on the set of ATSSS rules.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for improving a processing overhead associated with a PDU session. For example, the device 905 may receive signaling that supports ATSSS-Lite, such that the wireless network establishes the PDU session with a 3GPP access link and an NIN3A link. Using ATSSS-Lite to communicate using both the 3GPP access link and the NIN3A link may improve communication reliability and throughput, reducing communication latency and processing overhead associated with retransmissions.

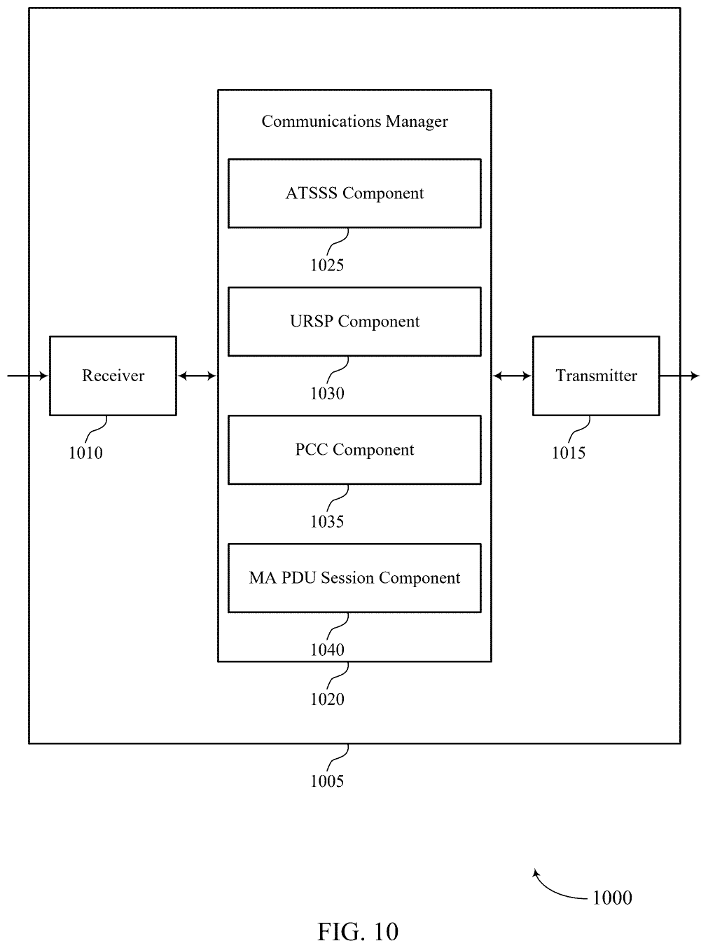

FIG. 10 shows a block diagram 1000 of a device 1005 that supports techniques for PDU sessions via multiple access networks in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, PDUs, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, PDUs, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for PDU sessions via multiple access networks as described herein. For example, the communications manager 1020 may include an ATSSS component 1025, an URSP component 1030, a PCC component 1035, a MA PDU session component 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The ATSSS component 1025 is capable of, configured to, or operable to support a means for obtaining, from a UE, an indication that the UE supports a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network. The URSP component 1030 is capable of, configured to, or operable to support a means for outputting a first signal to the UE that indicates the UE is to use the first type of ATSSS for the PDU session with the wireless network via at least one of the first access link and the second access link. The PCC component 1035 is capable of, configured to, or operable to support a means for outputting, to a second network entity that provides a SMF, a second signal that indicates one or more PCC parameters for the PDU session with the UE including at least one of the first access link and the second access link. The MA PDU session component 1040 is capable of, configured to, or operable to support a means for outputting, to the second network entity that provides the SMF an indication that the first signal indicating that the second access link is non-integrated in the wireless network has been sent to the UE.

Additionally, or alternatively, the communications manager 1020 may support wireless communications in accordance with examples as disclosed herein. The PCC component 1035 is capable of, configured to, or operable to support a means for obtaining, from a first network entity, a signal that indicates one or more PCC parameters for a PDU session with a UE, the PDU session including at least one of a first access link and a second access link. The PCC component 1035 is capable of, configured to, or operable to support a means for obtaining, from the first network entity, an indication that a first signal indicating that the second access link is non-integrated in the wireless network has been sent to the UE. The ATSSS component 1025 is capable of, configured to, or operable to support a means for outputting, to the UE and to a third network entity, a set of rules for a first type of ATSSS for the PDU session, where the first access link is associated with a first access technology corresponding to a wireless network and the second access link is associated with a second access technology different from the first access technology, and where the second access link is non-integrated in the wireless network.

Additionally, or alternatively, the communications manager 1020 may support wireless communications in accordance with examples as disclosed herein. The ATSSS component 1025 is capable of, configured to, or operable to support a means for obtaining a signal that indicates a set of N4/MAR rules for a first type of ATSSS for a PDU session with a UE via a first access link and a second access link, where the first access link is associated with a first access technology corresponding to the wireless network and the second access link is associated with a second access technology different from the first access technology, and where the second access link is non-integrated in the wireless network. The MA PDU session component 1040 is capable of, configured to, or operable to support a means for communicating with the UE via at least one of the first access link and the second access link based on the set of N4/MAR rules.

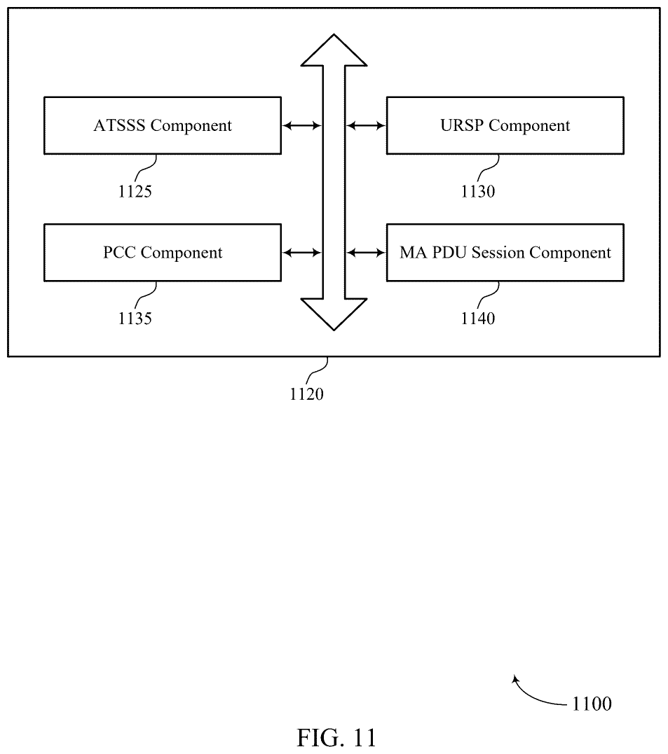

FIG. 11 shows a block diagram 1100 of a communications manager 1120 that supports techniques for PDU sessions via multiple access networks in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for PDU sessions via multiple access networks as described herein. For example, the communications manager 1120 may include an ATSSS component 1125, an URSP component 1130, a PCC component 1135, a MA PDU session component 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The ATSSS component 1125 is capable of, configured to, or operable to support a means for obtaining, from a UE, an indication that the UE supports a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network. The URSP component 1130 is capable of, configured to, or operable to support a means for outputting a first signal to the UE that provides a URSP that indicates the UE is to use the first type of ATSSS for the PDU session with the wireless network via at least one of the first access link and the second access link. The PCC component 1135 is capable of, configured to, or operable to support a means for outputting, to a second network entity that provides a SMF, a second signal that indicates one or more PCC parameters for the PDU session with the UE including at least one of the first access link and the second access link.

In some examples, the first signal provides URSP rules that provide an indication that a preference for the PDU session is for the first access link associated with the wireless network and the second access link that is non-integrated in the wireless network.

In some examples, in an absence of the first signal that indicates a URSP for the second access link is non-integrated in the wireless network, one or more ATSSS rules associated with a second type of ATSSS including a PDU session in which both access links that are integrated in the wireless network are to be used. In some examples, the first signal includes a set of bits having a value that is mapped to a route selection descriptor component type identifier associated with a PDU session in which the second access link is non-integrated in the wireless network.

In some examples, the first signal indicates a selection for an active standby steering mode associated with the first access link and one or more other access links that are non-integrated in the wireless network. In some examples, the first signal indicates a selection for a priority based steering mode associated with the first access link and one or more other access links that are non-integrated in the wireless network. In some examples, the first signal indicates a selection for an RSM associated with the first access link and one or more other access links that are non-integrated in the wireless network. In some examples, the first signal indicates a selection for load balancing steering mode over the first access link and one or more other access links that are non-integrated in the wireless network.

Additionally, or alternatively, the communications manager 1120 may support wireless communications in accordance with examples as disclosed herein. In some examples, the PCC component 1135 is capable of, configured to, or operable to support a means for obtaining, from a first network entity, a signal that indicates one or more PCC parameters for a PDU session with a UE, the PDU session including at least one of a first access link and a second access link. In some examples, the ATSSS component 1125 is capable of, configured to, or operable to support a means for outputting, to the UE and to a third network entity, a set of ATSSS rules for a first type of ATSSS for the PDU session, where the first access link is associated with a first access technology corresponding to a wireless network and the second access link is associated with a second access technology different from the first access technology, and where the second access link is non-integrated in the wireless network.

In some examples, the set of ATSSS rules provide an indication that a preference for the PDU session is for the first access link associated with the wireless network and the second access link that is non-integrated in the wireless network. In some examples, in an absence of an indication that a URSP for the second access link is non-integrated in the wireless network one or more ATSSS rules associated with a second type of ATSSS including a PDU session in which both access links that are integrated in the wireless network are to be used.

In some examples, the set of ATSSS rules indicates a selection for an active standby steering mode associated with the first access link and one or more other access links that are non-integrated in the wireless network. In some examples, the set of ATSSS rules indicates a selection for a priority based steering mode associated with the first access link and one or more other access links that are non-integrated in the wireless network. In some examples, the set of ATSSS rules indicates a selection for an RSM associated with the first access link and one or more other access links that are non-integrated in the wireless network. In some examples, the set of ATSSS rules indicates a selection for an RSM associated with the first access link and one or more other access links that are non-integrated in the wireless network.

Additionally, or alternatively, the communications manager 1120 may support wireless communications in accordance with examples as disclosed herein. In some examples, the ATSSS component 1125 is capable of, configured to, or operable to support a means for obtaining a signal that indicates a set of ATSSS rules for a first type of ATSSS for a PDU session with a UE via a first access link and a second access link, where the first access link is associated with a first access technology corresponding to the wireless network and the second access link is associated with a second access technology different from the first access technology, and where the second access link is non-integrated in the wireless network. The MA PDU session component 1140 is capable of, configured to, or operable to support a means for communicating with the UE via at least one of the first access link and the second access link based on the set of ATSSS rules.

In some examples, the set of ATSSS rules indicates a selection for an active standby steering mode associated with the first access link and one or more other access links that are non-integrated in the wireless network. In some examples, the set of ATSSS rules indicates a selection for a priority based steering mode associated with the first access link and one or more other access links that are non-integrated in the wireless network. In some examples, the set of ATSSS rules indicates a selection for an RSM associated with the first access link and one or more other access links that are non-integrated in the wireless network. In some examples, the set of ATSSS rules indicates a selection for a load balancing steering mode associated with the first access link and one or more other access links that are non-integrated in the wireless network.

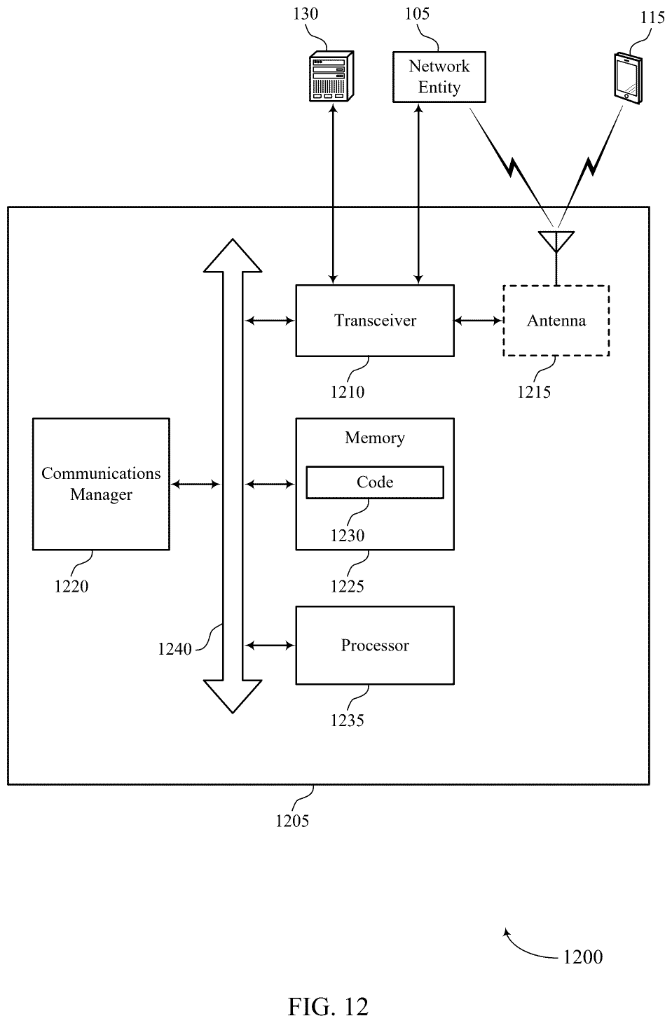

FIG. 12 shows a diagram of a system 1200 including a device 1205 that supports techniques for PDU sessions via multiple access networks in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for PDU sessions via multiple access networks). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for obtaining, from a UE, an indication that the UE supports a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network. The communications manager 1220 is capable of, configured to, or operable to support a means for outputting a first signal to the UE that provides a URSP that indicates the UE is to use the first type of ATSSS for the PDU session with the wireless network via at least one of the first access link and the second access link. The communications manager 1220 is capable of, configured to, or operable to support a means for outputting, to a second network entity that provides a SMF, a second signal that indicates one or more PCC parameters for the PDU session with the UE including at least one of the first access link and the second access link.

Additionally, or alternatively, the communications manager 1220 may support wireless communications in accordance with examples as disclosed herein. For example, the communications manager 1220 is capable of, configured to, or operable to support a means for obtaining, from a first network entity, a signal that indicates one or more PCC parameters for a PDU session with a UE, the PDU session including at least one of a first access link and a second access link. The communications manager 1220 is capable of, configured to, or operable to support a means for outputting, to the UE and to a third network entity, a set of ATSSS rules for a first type of ATSSS for the PDU session, where the first access link is associated with a first access technology corresponding to a wireless network and the second access link is associated with a second access technology different from the first access technology, and where the second access link is non-integrated in the wireless network.

Additionally, or alternatively, the communications manager 1220 may support wireless communications in accordance with examples as disclosed herein. For example, the communications manager 1220 is capable of, configured to, or operable to support a means for obtaining a signal that indicates a set of ATSSS rules for a first type of ATSSS for a PDU session with a UE via a first access link and a second access link, where the first access link is associated with a first access technology corresponding to the wireless network and the second access link is associated with a second access technology different from the first access technology, and where the second access link is non-integrated in the wireless network. The communications manager 1220 is capable of, configured to, or operable to support a means for communicating with the UE via at least one of the first access link and the second access link based on the set of ATSSS rules.

By including or configuring the communications manager 1220 in accordance with examples as described herein, the device 1205 may support techniques for improving a processing overhead associated with a PDU session. For example, the device 1205 may receive signaling that supports ATSSS-Lite, such that the wireless network establishes the PDU session with a 3GPP access link and an NIN3A link. Using ATSSS-Lite to communicate using both the 3GPP access link and the NIN3A link may improve communication reliability and throughput, reducing communication latency and processing overhead associated with retransmissions.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for PDU sessions via multiple access networks as described herein, or the at least one processor 1235 and the at least one memory 1225 may be otherwise configured to, individually or collectively, perform or support such operations.

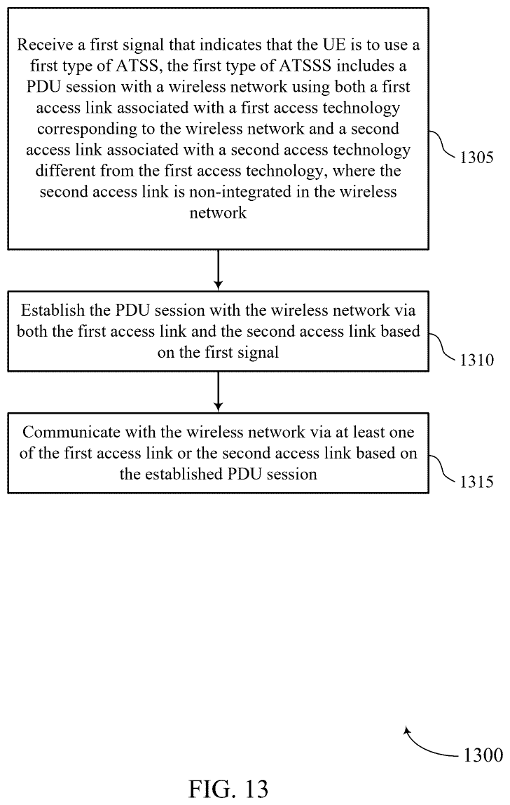

FIG. 13 shows a flowchart illustrating a method 1300 that supports techniques for PDU sessions via multiple access networks in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a first signal that indicates that the UE is to use a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network. The operations of 1305 may be performed in accordance with examples as disclosed herein. In some examples, aspects of the operations of 1305 may be performed by an ATSSS component 725 as described with reference to FIG. 7.

At 1310, the method may include establishing the PDU session with the wireless network via both the first access link and the second access link based on the first signal. The operations of 1310 may be performed in accordance with examples as disclosed herein. In some examples, aspects of the operations of 1310 may be performed by a MA PDU session component 730 as described with reference to FIG. 7.

At 1315, the method may include communicating with the wireless network via at least one of the first access link or the second access link based on the established PDU session. The operations of 1315 may be performed in accordance with examples as disclosed herein. In some examples, aspects of the operations of 1315 may be performed by a communication component 735 as described with reference to FIG. 7.

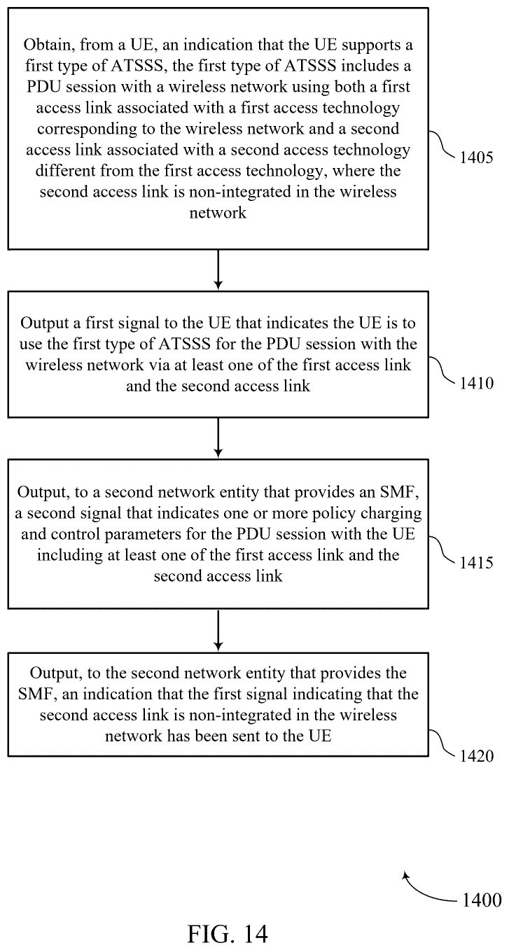

FIG. 14 shows a flowchart illustrating a method 1400 that supports techniques for PDU sessions via multiple access networks in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include obtaining, from a UE, an indication that the UE supports a first type of ATSSS, the first type of ATSSS includes a PDU session with a wireless network using both a first access link associated with a first access technology corresponding to the wireless network and a second access link associated with a second access technology different from the first access technology, where the second access link is non-integrated in the wireless network. The operations of 1405 may be performed in accordance with examples as disclosed herein. In some examples, aspects of the operations of 1405 may be performed by an ATSSS component 1125 as described with reference to FIG. 11.

At 1410, the method may include outputting a first signal to the UE that indicates the UE is to use the first type of ATSSS for the PDU session with the wireless network via at least one of the first access link and the second access link. The operations of 1410 may be performed in accordance with examples as disclosed herein. In some examples, aspects of the operations of 1410 may be performed by an URSP component 1130 as described with reference to FIG. 11.

At 1415, the method may include outputting, to a second network entity that provides a SMF, a second signal that indicates one or more PCC parameters for the PDU session with the UE including at least one of the first access link and the second access link. The operations of 1415 may be performed in accordance with examples as disclosed herein. In some examples, aspects of the operations of 1415 may be performed by a PCC component 1135 as described with reference to FIG. 11.

At 1420, the method may include outputting, to the second network entity that provides the SMF, an indication that the first signal indicating that the second access link is non-integrated in the wireless network has been sent to the UE. The operations of 1420 may be performed in accordance with examples as disclosed herein. In some examples, aspects of the operations of 1420 may be performed by an ATSSS component 1125 as described with reference to FIG. 11.

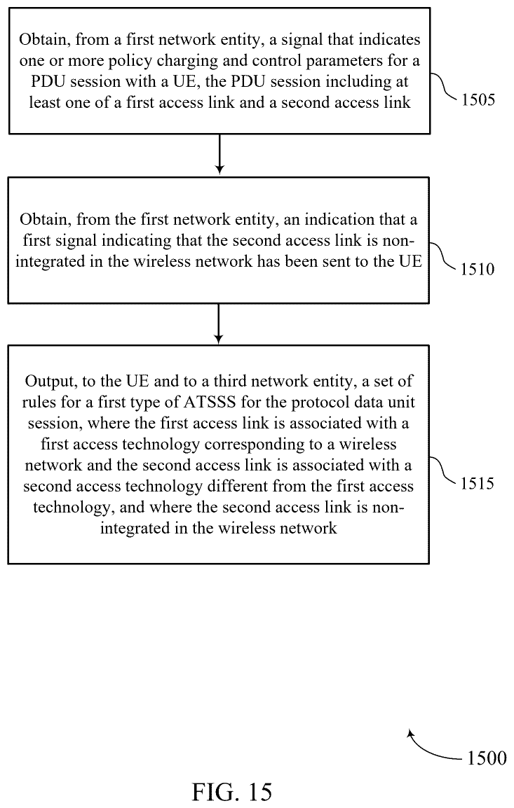

FIG. 15 shows a flowchart illustrating a method 1500 that supports techniques for PDU sessions via multiple access networks in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include obtaining, from a first network entity, a signal that indicates one or more PCC parameters for a PDU session with a UE, the PDU session including at least one of a first access link and a second access link. The operations of 1505 may be performed in accordance with examples as disclosed herein. In some examples, aspects of the operations of 1505 may be performed by a PCC component 1135 as described with reference to FIG. 11.

At 1510, the method may include obtaining, from the first network entity, an indication that a first signal indicating that the second access link is non-integrated in the wireless network has been sent to the UE. The operations of 1510 may be performed in accordance with examples as disclosed herein. In some examples, aspects of the operations of 1510 may be performed by a PCC component 1135 as described with reference to FIG. 11.

At 1515, the method may include outputting, to the UE and to a third network entity, a set of ATSSS rules for a first type of ATSSS for the PDU session, where the first access link is associated with a first access technology corresponding to a wireless network and the second access link is associated with a second access technology different from the first access technology, and where the second access link is non-integrated in the wireless network. The operations of 1515 may be performed in accordance with examples as disclosed herein. In some examples, aspects of the operations of 1515 may be performed by an ATSSS component 1125 as described with reference to FIG. 11.

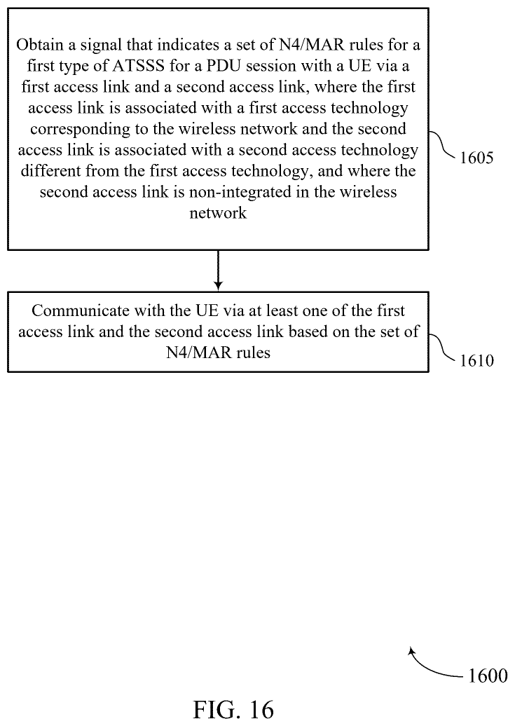

FIG. 16 shows a flowchart illustrating a method 1600 that supports techniques for PDU sessions via multiple access networks in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include obtaining a signal that indicates a set of N4/MAR rules for a first type of ATSSS for a PDU session with a UE via a first access link and a second access link, where the first access link is associated with a first access technology corresponding to the wireless network and the second access link is associated with a second access technology different from the first access technology, and where the second access link is non-integrated in the wireless network. The operations of 1605 may be performed in accordance with examples as disclosed herein. In some examples, aspects of the operations of 1605 may be performed by an ATSSS component 1125 as described with reference to FIG. 11.

At 1610, the method may include communicating with the UE via at least one of the first access link and the second access link based on the set of N4/MAR rules. The operations of 1610 may be performed in accordance with examples as disclosed herein. In some examples, aspects of the operations of 1610 may be performed by a MA PDU session component 1140 as described with reference to FIG. 11.

The following provides an overview of aspects of the present disclosure:

Aspect 1: A method for wireless communications at a UE, comprising: receiving a first signal that indicates that the UE is to use a first type of ATSSS, the first type of ATSSS includes a PDU session with a wireless network using both a first access link associated with a first access technology corresponding to the wireless network and a second access link associated with a second access technology different from the first access technology, wherein the second access link is non-integrated in the wireless network; establishing the PDU session with the wireless network via both the first access link and the second access link based at least in part on the first signal; and communicating with the wireless network via at least one of the first access link or the second access link based at least in part on the established PDU session.

Aspect 2: The method of aspect 1, wherein the receiving the first signal comprises: receiving the first signal from a PCF of the wireless network, wherein the first signal provides a URSP rule, and wherein the communicating with the wireless network is based at least in part on applying ATSSS rules associated with access links that are integrated to the wireless network to a first integrated access link together with a second non-integrated access link.

Aspect 3: The method of any of aspects 1 through 2, wherein the receiving the first signal comprises: receiving the first signal from a SMF of the wireless network that provides a set of ATSSS rules for the first type of ATSSS for the PDU session, wherein the set of ATSSS rules are for access links that are non-integrated in the wireless network.

Aspect 4: The method of any of aspects 1 through 3, wherein the first signal provides URSP rules that provide an indication that a preference for the PDU session is for the first access link associated with the wireless network and the second access link that is non-integrated in the wireless network.

Aspect 5: The method of any of aspects 1 through 4, wherein the UE, in an absence of the first signal that indicates a URSP for the second access link that is non-integrated in the wireless network, is to use a second type of ATSSS including a PDU session with the wireless network in which both access links are integrated in the wireless network, and the communicating with the wireless network uses, for both the first access link and the second access link, ATSSS rules that are associated with the second type of ATSSS.

Aspect 6: The method of any of aspects 1 through 5, wherein the first signal implicitly indicates that the second access link is non-integrated in the wireless network.

Aspect 7: The method of any of aspects 1 through 6, wherein the first signal includes a set of bits having a value that is mapped to a route selection descriptor component type identifier associated with a PDU session in which the second access link is non-integrated in the wireless network.

Aspect 8: The method of any of aspects 1 through 7, wherein the first signal indicates a selection for an active standby steering mode associated with the first access link and one or more other access links that are non-integrated in the wireless network.

Aspect 9: The method of any of aspects 1 through 8, wherein the first signal indicates a selection for a priority based steering mode associated with the first access link and one or more other access links that are non-integrated in the wireless network.

Aspect 10: The method of any of aspects 1 through 9, wherein the first signal indicates a selection for an RSM associated with the first access link and one or more other access links that are non-integrated in the wireless network.

Aspect 11: The method of any of aspects 1 through 10, wherein the first signal indicates a selection for load balancing steering mode over the first access link and one or more other access links that are non-integrated in the wireless network.

Aspect 12: A method for wireless communications at a first network entity, comprising: obtaining, from a UE, an indication that the UE supports a first type of ATSSS, the first type of ATSSS includes a PDU session with a wireless network using both a first access link associated with a first access technology corresponding to the wireless network and a second access link associated with a second access technology different from the first access technology, wherein the second access link is non-integrated in the wireless network; outputting a first signal to the UE that indicates the UE is to use the first type of ATSSS for the PDU session with the wireless network via at least one of the first access link and the second access link; outputting, to a second network entity that provides a SMF, a second signal that indicates one or more PCC parameters for the PDU session with the UE comprising at least one of the first access link and the second access link; and outputting, to the second network entity that provides the SMF, an indication that the first signal indicating that the second access link is non-integrated in the wireless network has been sent to the UE.

Aspect 13: The method of aspect 12, wherein the first signal provides URSP rules that provide an indication that a preference for the PDU session is for the first access link associated with the wireless network and the second access link that is non-integrated in the wireless network.

Aspect 14: The method of any of aspects 12 through 13, wherein in an absence of the first signal that indicates a URSP for the second access link is non-integrated in the wireless network, one or more ATSSS rules associated with a second type of ATSSS including a PDU session in which both access links that are integrated in the wireless network are to be used.

Aspect 15: The method of any of aspects 12 through 14, wherein the first signal includes a set of bits having a value that is mapped to a route selection descriptor component type identifier associated with a PDU session in which the second access link is non-integrated in the wireless network.

Aspect 16: The method of any of aspects 12 through 15, wherein the first network entity is a PCF.

Aspect 17: A method for wireless communications at a second network entity, comprising: obtaining, from a first network entity, a signal that indicates one or more PCC parameters for a PDU session with a UE, the PDU session comprising at least one of a first access link and a second access link; obtaining, from the first network entity, an indication that a first signal indicating that the second access link is non-integrated in the wireless network has been sent to the UE; and outputting, to the UE and to a third network entity, a set of rules for a first type of ATSSS for the PDU session, wherein the first access link is associated with a first access technology corresponding to a wireless network and the second access link is associated with a second access technology different from the first access technology, and wherein the second access link is non-integrated in the wireless network.

Aspect 18: The method of aspect 17, wherein the set of ATSSS rules provide an indication that a preference for the PDU session is for the first access link associated with the wireless network and the second access link that is non-integrated in the wireless network.

Aspect 19: The method of any of aspects 17 through 18, wherein in an absence of an indication that a first signal indicating that the second access link is non-integrated in the wireless network one or more rules associated with a second type of ATSSS including a PDU session in which both access links that are integrated in the wireless network are to be used.

Aspect 20: The method of any of aspects 17 through 19, wherein the set of ATSSS rules indicates a selection for an active standby steering mode associated with the first access link and one or more other access links that are non-integrated in the wireless network.

Aspect 21: The method of any of aspects 17 through 20, wherein the set of ATSSS rules indicates a selection for a priority based steering mode associated with the first access link and one or more other access links that are non-integrated in the wireless network.

Aspect 22: The method of any of aspects 17 through 21, wherein the set of ATSSS rules indicates a selection for an RSM associated with the first access link and one or more other access links that are non-integrated in the wireless network.

Aspect 23: The method of any of aspects 17 through 22, wherein the set of ATSSS rules indicates a selection for an RSM associated with the first access link and one or more other access links that are non-integrated in the wireless network.

Aspect 24: The method of any of aspects 17 through 23, wherein the set of rules are ATSSS rules sent to the UE.

Aspect 25: The method of any of aspects 17 through 24, wherein the set of rules are N4/Multi-Access-Rules (MAR) rules sent to a UPF.

Aspect 26: The method of any of aspects 17 through 25, wherein the second network entity is a SMF.

Aspect 27: A method for wireless communications at a third network entity of a wireless network, comprising: obtaining a signal that indicates a set of N4/MARs for a first type of ATSSS for a PDU session with a UE via a first access link and a second access link, wherein the first access link is associated with a first access technology corresponding to the wireless network and the second access link is associated with a second access technology different from the first access technology, and wherein the second access link is non-integrated in the wireless network; and communicating with the UE via at least one of the first access link and the second access link based at least in part on the set of N4/MARs.

Aspect 28: The method of aspect 27, wherein the set of N4/MARs indicates a selection for an active standby steering mode associated with the first access link and one or more other access links that are non-integrated in the wireless network.

Aspect 29: The method of any of aspects 27 through 28, wherein the set of N4/MARs indicates a selection for a priority based steering mode associated with the first access link and one or more other access links that are non-integrated in the wireless network.

Aspect 30: The method of any of aspects 27 through 29, wherein the set of N4/MARs indicates a selection for an RSM associated with the first access link and one or more other access links that are non-integrated in the wireless network.

Aspect 31: The method of any of aspects 27 through 30, wherein the set of N4/MARs indicates a selection for a load balancing steering mode associated with the first access link and one or more other access links that are non-integrated in the wireless network.

Aspect 32: The method of any of aspects 27 through 31, wherein the third network entity is a UPF.

Aspect 33: A UE for wireless communications, comprising one or more memories storing processor-executable code, and one or more processors coupled with the one or more memories and individually or collectively operable to execute the code to cause the UE to perform a method of any of aspects 1 through 11.

Aspect 34: A UE for wireless communications, comprising at least one means for performing a method of any of aspects 1 through 11.

Aspect 35: A non-transitory computer-readable medium storing code for wireless communications, the code comprising instructions executable by one or more processors to perform a method of any of aspects 1 through 11.

Aspect 36: A first network entity for wireless communications, comprising one or more memories storing processor-executable code, and one or more processors coupled with the one or more memories and individually or collectively operable to execute the code to cause the first network entity to perform a method of any of aspects 12 through 16.

Aspect 37: A first network entity for wireless communications, comprising at least one means for performing a method of any of aspects 12 through 16.

Aspect 38: A non-transitory computer-readable medium storing code for wireless communications, the code comprising instructions executable by one or more processors to perform a method of any of aspects 12 through 16.

Aspect 39: A second network entity for wireless communications, comprising one or more memories storing processor-executable code, and one or more processors coupled with the one or more memories and individually or collectively operable to execute the code to cause the second network entity to perform a method of any of aspects 17 through 26.

Aspect 40: A second network entity for wireless communications, comprising at least one means for performing a method of any of aspects 17 through 26.

Aspect 41: A non-transitory computer-readable medium storing code for wireless communications, the code comprising instructions executable by one or more processors to perform a method of any of aspects 17 through 26.

Aspect 42: A third network entity of a wireless network for wireless communications, comprising one or more memories storing processor-executable code, and one or more processors coupled with the one or more memories and individually or collectively operable to execute the code to cause the third network entity of a wireless network to perform a method of any of aspects 27 through 32.

Aspect 43: A third network entity of a wireless network for wireless communications, comprising at least one means for performing a method of any of aspects 27 through 32.

Aspect 44: A non-transitory computer-readable medium storing code for wireless communications, the code comprising instructions executable by one or more processors to perform a method of any of aspects 27 through 32.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first signal that indicates that the UE is to use a first type of access traffic steering-switching-splitting (ATSSS), the first type of ATSSS includes a protocol data unit session with a wireless network using both a first access link associated with a first access technology corresponding to the wireless network and a second access link associated with a second access technology different from the first access technology, wherein the second access link is non-integrated in the wireless network;
establish the protocol data unit session with the wireless network via both the first access link and the second access link based at least in part on the first signal; and
communicate with the wireless network via at least one of the first access link or the second access link based at least in part on the established protocol data unit session.

2. The UE of claim 1, wherein, to receive the first signal, the one or more processors are individually or collectively operable to execute the code to cause the UE to:
receive the first signal from a policy control function of the wireless network, wherein the first signal provides a UE route selection policy (URSP) rule, and wherein the communicating with the wireless network is based at least in part on applying ATSSS rules associated with access links that are integrated to the wireless network to a first integrated access link together with a second non-integrated access link.

3. The UE of claim 1, wherein, to receive the first signal, the one or more processors are individually or collectively operable to execute the code to cause the UE to:
receive the first signal from a session management function of the wireless network that provides a set of ATSSS rules for the first type of ATSSS for the protocol data unit session, wherein the set of ATSSS rules are for access links that are non-integrated in the wireless network.

4. The UE of claim 1, wherein the first signal provides UE route selection policy (URSP) rules that provide an indication that a preference for the protocol data unit session is for the first access link associated with the wireless network and the second access link that is non-integrated in the wireless network.

5. The UE of claim 1, wherein the UE, in an absence of the first signal that indicates a UE route selection policy (URSP) for the second access link that is non-integrated in the wireless network, is to use a second type of ATSSS including a protocol data unit session with the wireless network in which both access links are integrated in the wireless network, and the communicating with the wireless network uses, for both the first access link and the second access link, ATSSS rules that are associated with the second type of ATSSS.

6. The UE of claim 1, wherein the first signal implicitly indicates that the second access link is non-integrated in the wireless network.

7. The UE of claim 1, wherein the first signal includes a set of bits having a value that is mapped to a route selection descriptor component type identifier associated with a protocol data unit session in which the second access link is non-integrated in the wireless network.

8. The UE of claim 1, wherein the first signal indicates a selection for one of an active standby steering mode, a priority based steering mode, a redundant steering mode, and a load balancing steering mode associated with the first access link and one or more other access links that are non-integrated in the wireless network.

9. A second network entity, comprising:
one or more memories storing processor-executable code; and
one or more processors coupled with the one or more memories and individually or collectively operable to execute the code to cause the second network entity to:
obtain, from a first network entity, a signal that indicates one or more policy charging and control parameters for a protocol data unit session with a user equipment (UE), the protocol data unit session comprising at least one of a first access link and a second non-integrated access link;
obtain, from the first network entity, an indication that a first signal indicating that the second access link is non-integrated in a wireless network has been sent to the UE; and
output, to the UE and to a third network entity, a set of rules for a first type of access traffic steering-switching-splitting (ATSSS) for the protocol data unit session, wherein the first access link is associated with a first access technology corresponding to a wireless network and the second access link is associated with a second access technology different from the first access technology, and wherein the second access link is non-integrated in the wireless network.

10. The second network entity of claim 9, wherein the set of rules provide an indication that a preference for the protocol data unit session is for the first access link associated with the wireless network and the second access link that is non-integrated in the wireless network.

11. The second network entity of claim 9, wherein, in an absence of an indication that a first signal indicating that the second access link is non-integrated in the wireless network one or more rules associated with a second type of ATSSS including a protocol data unit session in which both access links that are integrated in the wireless network are to be used.

12. The second network entity of claim 9, wherein the set of rules indicates one of a selection for an active standby steering mode, a priority based steering mode, a redundant steering mode, and a load balancing steering mode associated with the first access link and one or more other access links that are non-integrated in the wireless network.

13. The second network entity of claim 9, wherein the set of rules are ATSSS rules sent to the UE.

14. The second network entity of claim 9, wherein the set of rules are N4/Multi-Access-Rules (MAR) rules sent to a User Plane Function (UPF).

15. The second network entity of claim 9, wherein the second network entity is a Session Management Function (SMF).

16. A method for wireless communications at a user equipment (UE), comprising:
receiving a first signal that indicates that the UE is to use a first type of access traffic steering-switching-splitting (ATSSS), the first type of ATSSS includes a protocol data unit session with a wireless network using both a first access link associated with a first access technology corresponding to the wireless network and a second access link associated with a second access technology different from the first access technology, wherein the second access link is non-integrated in the wireless network;
establishing the protocol data unit session with the wireless network via both the first access link and the second access link based at least in part on the first signal; and
communicating with the wireless network via at least one of the first access link or the second access link based at least in part on the established protocol data unit session.

17. The method of claim 16, wherein the receiving the first signal comprises:
receiving the first signal from a policy control function of the wireless network, wherein the first signal provides a UE route selection policy (URSP) rule, and wherein the communicating with the wireless network is based at least in part on applying ATSSS rules associated with access links that are integrated to the wireless network to a first integrated access link together with a second non-integrated access link.

18. The method of claim 16, wherein the receiving the first signal comprises:
receiving the first signal from a session management function of the wireless network that provides a set of ATSSS rules for the first type of ATSSS for the protocol data unit session, wherein the set of ATSSS rules are for access links that are non-integrated in the wireless network.

19. The method of claim 16, wherein the first signal provides UE route selection policy (URSP) rules that provide an indication that a preference for the protocol data unit session is for the first access link associated with the wireless network and the second access link that is non-integrated in the wireless network.

20. The method of claim 16, wherein the UE, in an absence of the first signal that indicates a UE route selection policy (URSP) for the second access link that is non-integrated in the wireless network, is to use a second type of ATSSS including a protocol data unit session with the wireless network in which both access links are integrated in the wireless network, and the communicating with the wireless network uses, for both the first access link and the second access link, ATSSS rules that are associated with the second type of ATSSS.

21. The method of claim 16, wherein the first signal implicitly indicates that the second access link is non-integrated in the wireless network.

22. The method of claim 16, wherein the first signal includes a set of bits having a value that is mapped to a route selection descriptor component type identifier associated with a protocol data unit session in which the second access link is non-integrated in the wireless network.

23. The method of claim 16, wherein the first signal indicates a selection for one of an active standby steering mode, a priority based steering mode, a redundant steering mode, and a load balancing steering mode associated with the first access link and one or more other access links that are non-integrated in the wireless network.

24. A method for wireless communications at a second network entity, comprising:
obtaining, from a first network entity, a signal that indicates one or more policy charging and control parameters for a protocol data unit session with a user equipment (UE), the protocol data unit session comprising at least one of a first access link and a second access link;
obtaining, from the first network entity, an indication that a first signal indicating that the second access link is non-integrated in a wireless network has been sent to the UE; and
outputting, to the UE and to a third network entity, a set of rules for a first type of access traffic steering-switching-splitting (ATSSS) for the protocol data unit session, wherein the first access link is associated with a first access technology corresponding to a wireless network and the second access link is associated with a second access technology different from the first access technology, and wherein the second access link is non-integrated in the wireless network.

25. The method of claim 24, wherein the set of rules provide an indication that a preference for the protocol data unit session is for the first access link associated with the wireless network and the second access link that is non-integrated in the wireless network.

26. The method of claim 24, wherein, in an absence of an indication that a first signal indicating that the second access link is non-integrated in the wireless network one or more rules associated with a second type of ATSSS including a protocol data unit session in which both access links that are integrated in the wireless network are to be used.

27. The method of claim 24, wherein the set of rules indicates a selection for one of an active standby steering mode, a priority based steering mode, a redundant steering mode, and a load balancing steering mode associated with the first access link and one or more other access links that are non-integrated in the wireless network.

28. The method of claim 24, wherein the set of rules are ATSSS rules sent to the UE.

29. The method of claim 24, wherein the set of rules are NA/Multi-Access-Rules (MAR) rules sent to a User Plane Function (UPF).

30. The method of claim 24, wherein the second network entity is a Session Management Function (SMP).
